(19) United States
(12) Patent Application Publication
(10) Pub. No.: US 2025/0330102 A1
(43) Pub. Date: Oct. 23, 2025

(54) ELECTRONIC POWER CONVERTER CIRCUIT APPARATUS PROVIDED WITH INVERTER CIRCUIT INCLUDING BRIDGE CIRCUIT WITH SWITCH ELEMENTS

(71) Applicant: Panasonic Intellectual Property Management Co., Ltd., Osaka (JP)

(72) Inventors: Taiki NISHIMOTO, Osaka (JP); Noriaki TAKEDA, Osaka (JP); Naoki SAWADA, Osaka (JP); Atsufumi KIKUCHI, Osaka (JP)

(21) Appl. No.: 18/868,126

(22) PCT Filed: May 10, 2023
(86) PCT No.: PCT/JP2023/017551

§ 371 Date: Nov. 21, 2024

(30) Foreign Application Priority Data
May 27, 2022 (JP) 2022-087124

(51) Int. Cl. H02M 7/5387; H02M 7/48

(52) U.S. Cl. CPC H02M 7/53871; H02M 7/4815

(57) ABSTRACT

An electric power converter circuit apparatus includes an inverter circuit between input terminals and output terminals. A first connection point is connected to the first output terminal via a first inductance, and a second connection point is connected to the second output terminal via a second inductance. A first impedance element is connected between the first connection point and the second input terminal, a second impedance element is connected between the second connection point and the second input terminal, a third impedance element is connected between the first output terminal and the second input terminal, and a fourth impedance element is connected between the second output terminal and the second input terminal.

### TECHNICAL FIELD

The present disclosure relates to an electric power converter circuit apparatus including, for example, an inverter circuit.

### BACKGROUND ART

A motor system is generally mounted on industrial equipment such as a processing machine and a mounting machine. An electric power unit of the motor system includes the following five blocks:
(1) an electric power cable connected to an AC power supply in a factory;
(2) a rectifier circuit that converts AC power into DC power;
(3) an inverter circuit that generates a pulse width modulation (PWM) signal from DC power;
(4) a motor; and
(5) a motor cable connecting the inverter circuit and the motor.

Among these, in the inverter circuit of (3), PWM control is realized by switching of an insulated gate bipolar transistor (IGBT) or a metal oxide semiconductor field-effect transistor (MOSFET). In a similar manner to that of the electric power converter circuit such as a DC-DC converter, electromagnetic noise is generated at the time of switching, and thus it is necessary to take measures using a noise filter or the like.

The electromagnetic noise is classified into conduction noise and radiation noise. Among them, the radiation noise is easily radiated into the space from a long conductor such as a cable. In a factory, there is a case where a rack for storing an inverter circuit is provided separately from equipment for incorporating a motor because there is a small space in the equipment. At this time, since the motor cable becomes long, the dominant radiation source of the radiation noise is the motor cable.

In addition, it is generally known that the noise component in the common mode easily contributes to the radiation noise as compared with the differential mode. Therefore, in order to suppress the radiation noise of the motor system in the factory environment, it is important to reduce the noise component of the “common mode” flowing in the “motor cable”.

Patent Document 1 discloses a circuit configuration that reduces common mode noise of an inverter circuit using an active element such as a transistor.

### PRIOR ART DOCUMENT

### Patent Document

Patent Document 1: Japanese patent No. JP6803478B1.

### SUMMARY OF THE INVENTION

### Problems to be Solved by the Invention

A method of canceling noise using an active device is characterized by high noise reduction performance. On the other hand, due to the limit of the frequency response performance of the active element and the nonlinear frequency characteristic of the magnetic component for noise detection, the performance is likely to deteriorate in the high frequency band in which the radiation noise is a problem. In addition, components with good frequency characteristics are expensive. Therefore, it is required to reduce the “common mode” noise component of the “high frequency” flowing through the “motor cable” using the “passive component”.

An object of the present disclosure is to provide an electric power converter circuit apparatus that can reduce common mode noise flowing through a motor cable without using an expensive active component or a large noise countermeasure component in an electric power converter circuit apparatus including an inverter circuit, for example, and thus can suppress radiation noise.

### Solutions to the Problems

According to one aspect of the disclosure, there is provided an electric power converter circuit apparatus including an inverter circuit including a bridge circuit. The inverter circuit is provided between first and second input terminals and first and second output terminals. The bridge circuit is configured by connecting in parallel: a first series circuit including first and second switch elements connected in series to each other; and a second series circuit including third and fourth switch elements connected in series to each other. Both ends of the first series circuit and both ends of the second series circuit are defined as first and second connection points, respectively, and are connected to the first and second input terminals via first and second inductances. A third connection point of the first and second switch elements is connected to the first output terminal via a third inductance, and a fourth connection point of the third and fourth switch elements is connected to the second output terminal via a fourth inductance. The electric power converter circuit apparatus includes: a first impedance element connected between the third connection point and the first or second input terminal; a second impedance element connected between the fourth connection point and the first or second input terminal; a third impedance element connected between the first output terminal and the first or second input terminal; and a fourth impedance element connected between the second output terminal and the first or second input terminal.

### Effects of the Invention

Therefore, according to the electric power converter circuit apparatus according to one aspect of the present disclosure, for example, the common mode noise flowing through the motor cable of the electric power supply circuit related to the inverter circuit can be reduced, and this leads to that the radiation noise can be suppressed. As a result, as compared with the conventional inverter circuit, it is possible to reduce the number of noise countermeasure components, reduce the size and weight of the device, and reduce the cost.

### BRIEF DESCRIPTION OF THE DRAWINGS

FIG. 1 is a circuit diagram showing a configuration of an electric power converter circuit apparatus according to a single-phase inverter circuit according to First Comparative Example.

FIG. 2 is a circuit diagram showing a configuration example of an electric power converter circuit apparatus according to a first embodiment.

FIG. 3 is an equivalent circuit diagram in a radiation noise band of the electric power converter circuit apparatus of FIG. 2.

FIG. 4A is a circuit diagram showing a first configuration example of an impedance element A1 of the electric power converter circuit apparatus of FIG. 2.

FIG. 4B is a circuit diagram showing a second configuration example of the impedance element A1 of the electric power converter circuit apparatus of FIG. 2.

FIG. 4C is a circuit diagram showing a third configuration example of the impedance element A1 of the electric power converter circuit apparatus of FIG. 2.

FIG. 4D is a circuit diagram showing a fourth configuration example of the impedance element A1 of the electric power converter circuit apparatus of FIG. 2.

FIG. 4E is an equivalent circuit diagram showing a configuration example of a ferrite bead BD1 of FIG. 4D.

FIG. 5 is an equivalent circuit diagram in the radiation noise band of the electric power converter circuit apparatus of FIG. 2.

FIG. 6 is a spectrum diagram showing a comparison of common mode current suppression effects in the electric power converter circuit apparatus of FIGS. 1 and 2.

FIG. 7 is a circuit diagram showing a configuration example of an electric power converter circuit apparatus according to a modification of the first embodiment.

FIG. 8 is an equivalent circuit diagram in a radiation noise band of the electric power converter circuit apparatus of FIG. 7.

FIG. 9 is an equivalent circuit diagram in the radiation noise band of the electric power converter circuit apparatus of FIG. 7.

FIG. 10 is a circuit diagram showing a configuration example of an electric power converter circuit apparatus according to a second embodiment.

FIG. 11 is an equivalent circuit diagram in a radiation noise band of the electric power converter circuit apparatus of FIG. 10.

FIG. 12 is an equivalent circuit diagram in the radiation noise band of the electric power converter circuit apparatus of FIG. 10.

FIG. 13 is a spectrum diagram showing a comparison of common mode current suppression effects of the electric power converter circuit apparatus of FIGS. 1 and 10.

FIG. 14 is a circuit diagram showing a configuration example of an electric power converter circuit apparatus according to a third embodiment.

FIG. 15 is a circuit diagram showing a configuration example of an electric power converter circuit apparatus according to a fourth embodiment.

FIG. 16 is a circuit diagram showing a configuration of an electric power converter circuit apparatus according to a three-phase inverter circuit of Second Comparative Example.

FIG. 17 is a circuit diagram showing a configuration example of an electric power converter circuit apparatus according to a fifth embodiment.

FIG. 18 is an equivalent circuit diagram in the radiation noise band of the electric power converter circuit apparatus of FIG. 17.

FIG. 19 is an equivalent circuit diagram in the radiation noise band of the electric power converter circuit apparatus of FIG. 17.

FIG. 20 is a spectrum diagram showing a comparison of common mode current suppression effects of the electric power converter circuit apparatus of FIGS. 16 and 17.

FIG. 21 is a circuit diagram showing a configuration example of an electric power converter circuit apparatus according to a sixth embodiment.

FIG. 22 is an equivalent circuit diagram in the radiation noise band of the electric power converter circuit apparatus of FIG. 21.

FIG. 23 is an equivalent circuit diagram in the radiation noise band of the electric power converter circuit apparatus of FIG. 21.

FIG. 24 is an equivalent circuit diagram in the radiation noise band of the electric power converter circuit apparatus of FIG. 21.

FIG. 25 is an equivalent circuit diagram in the radiation noise band of the electric power converter circuit apparatus of FIG. 21.

FIG. 26 is a spectrum diagram showing a comparison of common mode current suppression effects of the electric power converter circuit apparatus of FIGS. 16 and 21.

FIG. 27 is a circuit diagram showing a configuration example of an electric power converter circuit apparatus according to a seventh embodiment.

### DETAILED DESCRIPTION

Hereinafter, embodiments and modifications according to the present disclosure will be described with reference to the drawings. It is noted that the same or similar components are denoted by the same reference numerals.

### Findings of Inventors

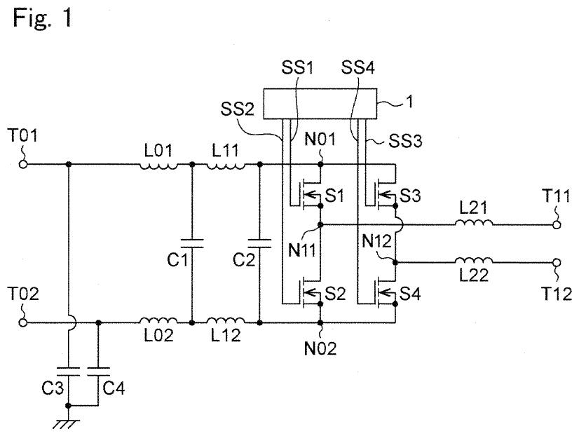

FIG. 1 is a circuit diagram showing a configuration of an electric power converter circuit apparatus according to a single-phase inverter circuit according to First Comparative Example. Referring to FIG. 1, a smoothing circuit and, for example, a PWM system switching inverter circuit are inserted between input terminals T01 and T02 and output terminals T11 and T12.

A DC voltage of DC power is applied between the input terminal T01 and the input terminal T02. The input terminal T01 is connected to a node N01 via the inductors L01 and L11, and the input terminal T02 is connected to a node N02 via the inductors L02 and L12. The connection point between the inductor L01 and the inductor L11 is connected to the connection point between the inductors L02 and L12 via a capacitor C1, and the node N01 is connected to the node N02 via a capacitor C2. The input terminal T01 is grounded via a capacitor C3, and the input terminal T02 is grounded via a capacitor C4.

In this case, the capacitors C1 and C2 are X capacitors, for example, the capacitor C1 is a smoothing capacitor, and the capacitor C2 is a snubber capacitor. The capacitors C3 and C4 are Y capacitors for noise countermeasures. The inductors L01, L02, L11, L12, L21, and L22 are wiring inductances or choke coils. Switch elements S1 to S4 are, for example, N-channel MOS transistors, and switch elements S1 and S2, and S3 and S4 are connected in series to form a full bridge circuit. In this case, the node N01 is connected to the node N02 via the drain and source of the switch element S1 and the drain and source of the switch element S2, and the node N01 is connected to the node N02 via the drain and source of the switch element S3 and the drain and source of the switch element S4. A node N11, which is a connection point between the source of the switch element S1 and the drain of the switch element S2, is connected to the output terminal T11 via the inductor L21, and a node N12, which is a connection point between the source of the switch element S3 and the drain of the switch element S4, is connected to the output terminal T12 via the inductor L22.

A controller circuit 1 generates known command signals SS1 to SS4 for performing PWM system switching (two phases) and outputs the command signals SS1 to SS4 to the gates of the switch elements S1 to S4, respectively. As a result, the switch elements S1 to S4 are switched on or off, and desired PWM voltages are generated at the output terminals T11 and T12.

At this time, when a common mode current flowing through the inductors L21 and L22 in phase is generated and propagates from the output terminals T11 and T12 to, for example, a motor cable connected to a motor of a load, the radiation noise increases. In order to suppress the common mode current, it is necessary to take measures such as sandwiching the ferrite core in the motor cable, which causes additional cost and increases the size and further the weight of the equipment.

In view of the knowledge of these problems, the present inventors have devised an electric power converter circuit apparatus according to the following embodiments and modifications in order to solve the problems.

### First Embodiment

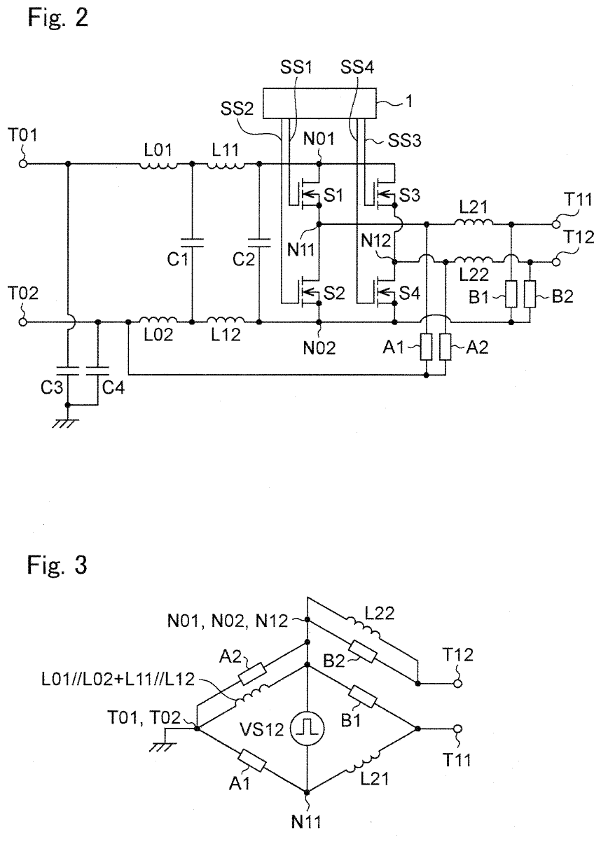

FIG. 2 is a circuit diagram showing a configuration example of an electric power converter circuit apparatus according to the first embodiment. The electric power converter circuit apparatus of FIG. 2 is different from the electric power converter circuit apparatus of FIG. 1 in the following point:
(1) impedance elements A1, A2, B1, and B2 are further included.

Differences will be described below.

Referring to FIG. 2, the impedance element A1 is connected between the node N11 and the input terminal T02, and the impedance element A2 is connected between the node N12 and the input terminal T02. The impedance element B1 is connected between the node N02 and the output terminal T11, and the impedance element B2 is connected between the node N02 and the output terminal T12.

In the frequency band (radiation noise band) of 30 MHz to 300 MHz where radiation noise becomes a problem, the impedances Z (=1/(21πfC)) of capacitors C1 to C4 are sufficiently smaller than those of other elements, and thus can be approximated to a short circuit (where Z is nearly equal to zero).

FIG. 3 is an equivalent circuit diagram in the radiation noise band of the electric power converter circuit apparatus of FIG. 2 in this approximate state. Referring to FIG. 2, when the capacitor C2 is approximated to a short circuit, the potentials of the nodes N01 and N02 are equal to each other, and thus, the drain-source voltage of the switch element S1 and the source-drain voltage of a switch element S2 are equal to each other, which is represented by the voltage source VS12 of FIG. 3. Referring to FIG. 3, in order to focus on noise propagation from the pair of switch elements S1 and S2 of the first phase (hereinafter, referred to as a “switch element pair”), the pair of switch elements S3 and S4 of the second phase is regarded as a short circuit. This is because the voltage sources other than the focused voltage source can be considered as a short circuit from the principle of superposition. It is noted that a symbol “X//Y” in the drawing represents a parallel connection circuit of an element X and an element Y. Further, in FIG. 3, since the capacitor C3 and the capacitor C4 are short-circuited and approximated, “the input terminal T01 and the input terminal T02 are regarded as the same node in the radiation noise band, and the same applies hereinafter.

As is apparent from FIG. 3, the impedance elements A1 and B1 are added from the voltage source VS12 to the first-phase output terminal T11, and this configures a bridge circuit. Therefore, although the detailed principle will be described later, noise propagation from the voltage source VS12 to the output terminal T11 can be reduced by the impedance balance method. In a similar manner to that of above, noise propagation from the pair of switch elements S3 and S4 of the second phase to the output terminal T12 can also be reduced. As a result, it is possible to suppress the common mode current propagating in the wiring extending from the output terminals T11 and T12, and it is possible to reduce the cost and reduce the size and weight by reducing the radiation noise and reducing the number of countermeasure components.

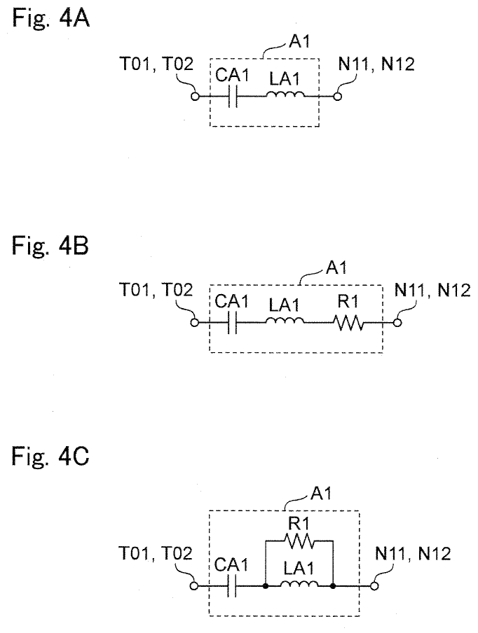

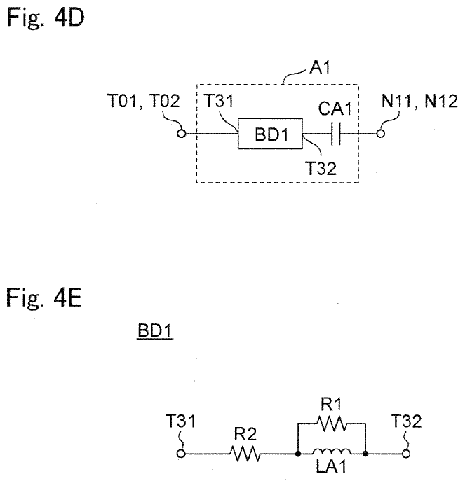

FIGS. 4A to 4D are circuit diagrams showing first to fourth configuration examples of the impedance element A1 of the electric power converter circuit apparatus of FIG. 2. As means for realizing the impedance elements A1, A2, B1, and B2, a series circuit of an inductor and a capacitor will be considered. The impedance element A1 is represented, for example, as shown in FIG. 4A, and the impedance elements A2, B1, and B2 can be similarly represented.

That is, in FIG. 4A, the impedance element A1 is represented by, for example, a series circuit of a capacitor CA1 and an inductor LA1. Similarly,
(1) the impedance element A2 is represented by, for example, a series circuit of a capacitor CA2 and an inductor LA2;
(2) the impedance element B1 is represented by, for example, a series circuit of a capacitor CB1 and an inductor LB1; and
(3) the impedance element B2 is represented by, for example, a series circuit of a capacitor CB2 and an inductor LB2.

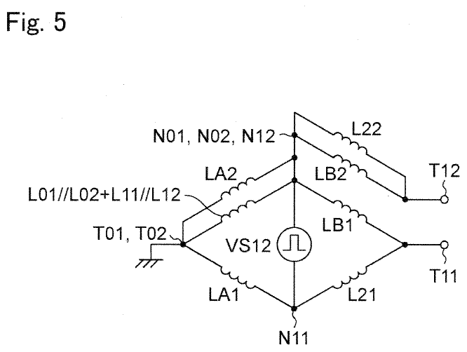

Referring to FIG. 4A, due to the presence of the capacitor CA1, the terminals of the impedance element A1 are insulated from each other in terms of direct current, so that generation of a PWM voltage similar to that of the inverter circuit according to First Comparative Example can be realized. Furthermore, in the radiation noise band, the impedance of the capacitor CA1 is sufficiently smaller than that of other elements, and thus can be approximated to a short circuit. Therefore, the impedance of the inductor LA1 is dominant in the radiation noise band. At this time, the equivalent circuit of FIG. 3 can be specifically represented as in FIG. 5.

In the present specification, the inductances of the inductors L are represented by the same symbol L, and the capacitance values of the capacitors C are represented by the same symbol C. In addition, the inductance L01 and the inductance L1 are different, and the inductance L02 and the inductance L2 are different.

FIG. 5 is an equivalent circuit diagram in the radiation noise band of the electric power converter circuit apparatus of FIG. 2. Referring to FIG. 5, since the components of the bridge circuit are only inductors, a large noise reduction effect can be obtained in a wide band by the impedance balance method. It also facilitates the designing. In order to make the impedance of the inductor LA1 dominant in the radiation noise band as described above, it is necessary to design the series resonance frequency of the capacitor CA1 and the inductor LA1 to be equal to or less than the radiation noise band.

A resister element may be further added to the impedance elements A1, A2, B1, and B2 in series or in parallel with the inductor. That is,
(1) as shown in FIG. 4B, the impedance element A1 may be configured by a series circuit of a resistor R1, the inductor LA1, and the capacitor CA1, and the same applies to the impedance elements A2, B1, and B2; and
(2) as shown in FIG. 4C, the impedance element A1 may be configured by a series circuit of the resistor R1, the inductor LA1, and the capacitor CA1 connected in parallel, and the same applies to the impedance elements A2, B1, and B2.

As a result, the impedance at the self-resonance frequency of the impedance elements A1, A2, B1, and B2 can be stabilized, and occurrence of noise peaks can be avoided. That is, the noise reduction effect can be obtained in a wide band.

As the impedance element including the inductor, a ferrite bead BD1 may be used. That is, as shown in FIG. 4D, the impedance element A1 may be configured by a series circuit of a ferrite bead BD1 and the capacitor CA1, and the same applies to the impedance elements A2, B1, and B2. The equivalent circuit of the ferrite bead BD1 is generally represented by, for example, a circuit (FIG. 4E) in which another resistor R2 is connected in series to a parallel circuit of the inductor LA1 and the resistor R1. As described above, when the ferrite bead BD1 is used, since the resistance component is contained, the noise reduction effect can be stably obtained without using the resister element.

Next, the conditions for maximizing the noise reduction effect will be described.

In the equivalent circuit of FIG. 5, the upper left component of the bridge circuit with respect to the output terminal T11 is represented by LA2//(L01//L02+L11//L12). The inductance of the combined inductors is indicated by L1. The lower left, upper right, and lower right components of the bridge circuit are inductors LA1, LB1, and L21 in this order. Focusing on the circuit on the left side of the bridge circuit of FIG. 5, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of the nodes N01, N02, and N12 is indicated by that L1/(L1+LA1)×VS12.

Next, focusing on the circuit on the right side of the bridge circuit, the voltage across the voltage source VS12 is divided by the inductors at the upper right and lower right of the bridge circuit. That is, the voltage of LB1/(LB1+L21)×VS12 is applied to the inductor at the upper right of the bridge circuit. In this case, in the case of L1/(L1+LA1)×VS12=LB1/(LB1+L21)×VS12, then the potential of the output terminal T11 becomes zero V. Since the ground potential is zero V, it means that no common mode voltage is generated.

Therefore, when this condition is satisfied, a remarkable noise reduction effect is expected.

The above design conditional expression can be expressed by that L1:LA1=LB1:L21 in a form of inductance ratio. This is the impedance balance method. L01//L02+L11//L12 is rephrased as an effective inductance between the input terminal T01 and the node N01 when the input terminal T01 and the input terminal T02 are short-circuited and the node N01 and the node N02 are short-circuited.

Therefore, the above optimum condition will be described as follows. When (A) each of the inductances of the impedance elements A1 and A2 or the inductance of the bead is L2;
(B) the inductance of the parallel inductor of the effective inductance between the input terminal T01 and the node N01, and the inductor L2 is L1 when the input terminal T01 and the input terminal T02 are short-circuited and the nodes N01 and N02 are short-circuited;
(C) each of the inductances of the impedance elements B1 and B2 or the inductance of the bead is L3; and
(D) each of the inductances of the inductors L21 and L22 is L4, then the condition can be indicated by that L1:L2=L3:L4.

In any of the embodiments, a common mode choke coil in which the inductors L01 and L02 are coupled may be used, or a common mode choke coil in which the inductors L11 and L12 are coupled may be used. Also in this case, design may be performed based on the above-described “effective inductance between the input terminal T01 and the node N01 when the input terminal T01 and the input terminal T02 are short-circuited and the nodes N01 and N02 are short-circuited”. For example, when a common mode choke coil in which L01 and L02 (=L01) are coupled with a coupling degree k0 and a common mode choke coil in which L11 and L12 (=L11) are coupled with a coupling degree k1 are used, the effective inductance between the input terminal T01 and the node in the bridge circuit is indicated by that L01×(1+k0)/2+L11×(1+k1)/2.

Although inferior to the above optimum conditions, the effect of noise reduction is expected even under the following conditions. The range in which the voltage applied to the upper right component of the bridge circuit of FIG. 5 is, for example, 0.5 to 1.5 times the voltage applied to the upper left component of the bridge circuit will be considered.

$$At 0.5 times , L 1 / ( L 1 + LA 1 ) \times VS 12 = 0.5 \times LB 1 / ( LB 1 + L 21 ) \times VS 12. \qquad ( 1 )$$

$$At 1.5 times , L 1 / ( L 1 + LA 1 ) \times VS 12 = 1.5 \times LB 1 / ( LB 1 + L 21 ) \times VS 12. \qquad ( 2 )$$

Therefore, in the equation of L1/(L1+LA1)×VS12=ax LB1/(LB1+L21)×VS12, that is, in the equation of L1/(L1+LA1)=ax LB1/(LB1+L21), when the coefficient “a” is 0.5≤a≤1.5 (when each element value is set in this way and the equation is established), the noise reduction effect is expected.

The effects of the electric power converter circuit apparatus according to the first embodiment will be shown using circuit simulation. The circuit parameters are as follows. However, the parenthesis indicates parasitic components considered in series.

$$C 1 = 1 mF ( 10 nH , 10 m Ω ) ,$$

$$C 2 = 100 nF ( 1 nH , 10 m Ω ) ,$$

$$C 3 = C 4 = 4.7 nF ( 10 nH , 0.2 Ω ) ,$$

$$L 01 = L 02 = L 11 = L 12 = 0.5 μH ,$$

$$L 21 = L 22 = 0.5 μ H .$$

In addition, the impedance elements A1 and A2 are series circuits of 0.5 μH, 200 pF, and 30Ω, and the impedance elements B1 and B2 are series circuits of 0.25 μH, 200 pF, and 30Ω. A DC voltage of 282 V is input between the input terminal T01 and the input terminal T02, and the switching frequency (carrier frequency) of the switch elements S1 to S4 is set to 12 kHz. The common mode currents in a case where a 5 m-long motor cable (T-type equivalent circuit) and a motor (winding inductance of 1 μH, parasitic capacitance between winding and housing of 0.5 nF) as a load are connected to the output terminals T11 and T12 of the inverter circuit are compared.

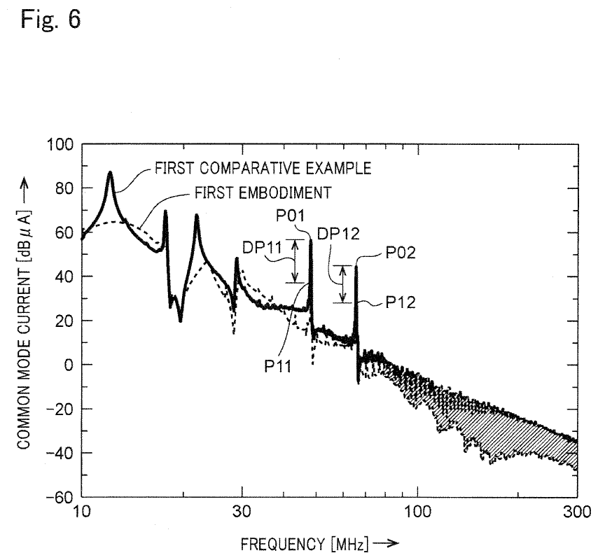

FIG. 6 is a spectrum diagram showing comparison of common mode currents in the electric power converter circuit apparatus of FIGS. 1 and 2. As is apparent from FIG. 6, it can be confirmed that a suppression effect of 10 dB to 20 dB can be obtained at the noise peak that tends to cause a problem of the radiation noise band. In particular, there are a suppression effect DP11 (=P01−P11) at about 50 MHz and a suppression effect DP12 (=P02−P12) at about 70 MHz. In this case, P01 and P02 are peaks of the common mode current of First Comparative Example, and P11 and P12 are peaks of the common mode current of the first embodiment.

Even if the impedance elements A1 and A2 are connected to the input terminal T01 instead of the input terminal T02, the same effect can be obtained. Even if the impedance elements B1 and B2 are connected to the node N01 instead of the node N02, a similar effect is obtained.

### Modifications of First Embodiment

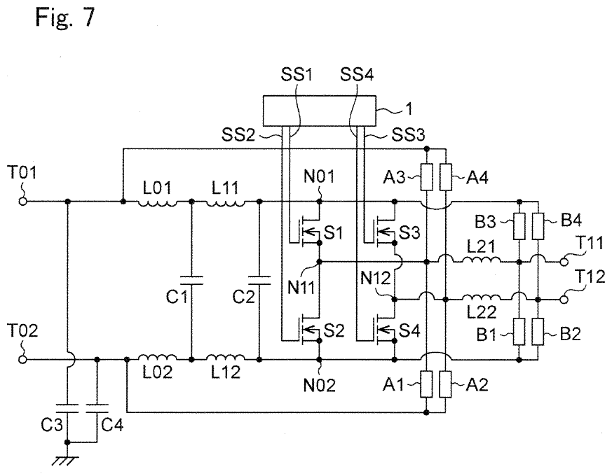

FIG. 7 is a circuit diagram showing a configuration example of an electric power converter circuit apparatus according to a modification of the first embodiment. The electric power converter circuit apparatus of FIG. 7 is different from the electric power converter circuit apparatus of FIG. 2 in the following points:
(1) impedance elements A3, A4, B3, and B4 are further included.

Differences will be described below.

Referring to FIG. 7, the impedance element A3 is connected between the node N11 and the input terminal T01, and the impedance element A4 is connected between the node N12 and the input terminal T01. The impedance element B3 is connected between the node N01 and the output terminal T11, and the impedance element B4 is connected between the node N01 and the output terminal T12.

Even in the modification of FIG. 7 configured as described above, the noise reduction effect can be obtained for the same reason as in the first embodiment of FIG. 2. However, since the design conditional expressions are different, they will be described below.

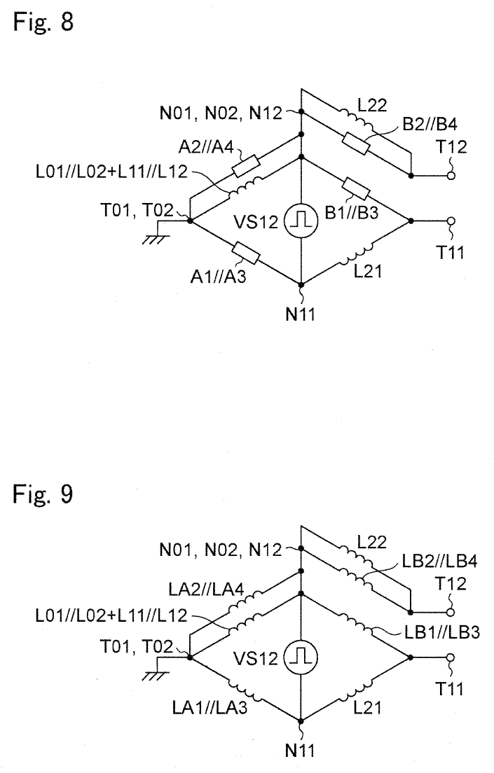

The impedance elements A1 to A4 and B1 to B4 are connected to both the positive electrode and the negative electrode, but in the equivalent circuit, the input terminal T01 and the input terminal T02, and the node N01 and the node N02 are considered to have the same potential. Therefore, the equivalent circuit has the same circuit configuration as that of the first embodiment, and is specifically shown in FIG. 8.

FIG. 8 is an equivalent circuit diagram in a radiation noise band of the electric power converter circuit apparatus of FIG. 7. As is apparent from FIG. 8, similarly to FIG. 3, a bridge circuit is configured from the voltage source VS12 to the first-phase output terminal T11. Therefore, noise propagation from the voltage source VS12 to the output terminal T11 can be reduced by the impedance balance method. In a similar manner to above, noise propagation from the pair of switch elements S3 and S4 of the second phase to the output terminal T12 can also be reduced. As a result, it is possible to suppress the common mode current propagating in the wiring extending from the output terminals T11 and T12, and it is possible to reduce the cost and reduce the size and weight by reducing the radiation noise and reducing the number of countermeasure components.

As means for realizing the impedance elements A1 to A4 and B1 to B4, a series circuit of an inductor and a capacitor will be considered. For example, when the impedance element A1 is shown in a circuit diagram, for example, the impedance element A1 is shown as in FIG. 4A, and the impedance elements A2 to A4 and B1 to B4 are similarly shown. In this case,
(1) the impedance element A3 is represented by, for example, a series circuit of a capacitor CA3 and an inductor LA3;
(2) the impedance element A4 is represented by, for example, a series circuit of a capacitor CA4 and an inductor LA4;
(3) the impedance element B3 is represented by, for example, a series circuit of a capacitor CB3 and an inductor LB3; and
(4) the impedance element B4 is represented by, for example, a series circuit of a capacitor CB4 and an inductor LB4.

In the impedance element A1, due to the presence of the capacitor CA1, the terminals of the impedance element A1 are insulated from each other in terms of direct current, so that generation of a PWM voltage similar to that of the inverter circuit according to First Comparative Example can be realized. Furthermore, in the radiation noise band, the impedance of the capacitor CA1 is sufficiently smaller than that of other elements, and thus can be approximated to a short circuit. Therefore, the impedance of the inductor LA1 is dominant in the radiation noise band. At this time, the equivalent circuit of FIG. 8 can be specifically represented as in FIG. 9.

FIG. 9 is an equivalent circuit diagram in a radiation noise band of the electric power converter circuit apparatus of FIG. 7. As is apparent from FIG. 9, since the components of the bridge circuit are configured by only inductors, a large noise reduction effect can be obtained in a wide band by the impedance balance method. It also facilitates the designing.

In order to make the impedance of the inductor LA1 dominant in the radiation noise band as described above, it is necessary to design the series resonance frequency of the capacitor CA1 and the inductor LA1 to be equal to or less than the radiation noise band.

In this case, as shown in FIGS. 4B to 4D, a resister element may be further added to the impedance elements A1 to A4 and B1 to B4 in series or in parallel with the inductor. As a result, the impedance at the self-resonance frequency of the impedance elements can be stabilized, and occurrence of noise peaks can be avoided. That is, the noise reduction effect can be obtained in a wide band. As the impedance elements A1 to A4 and B1 to B4 each including the inductor, a ferrite bead BD1 may be used. The equivalent circuit of the ferrite bead BD1 is generally represented by, for example, a circuit (FIG. 4E) in which another resistor R2 is connected in series to a parallel circuit of the inductor LA1 and the resistor R1. As described above, when the ferrite bead BD1 is used, since the resistance component is contained, the noise reduction effect can be stably obtained without using the resister element.

Next, conditions for maximizing the noise reduction effect will be described.

In the equivalent circuit of FIG. 9, the upper left component of the bridge circuit with respect to the output terminal T11 is represented by LA2//LA4//(L01//L02+L11//L12). An inductance of the combined inductor is an inductance L1. The inductance of this combined inductors of the lower left component LA1//LA3 of the bridge circuit is indicated by L2. The inductance of the combined inductors of the upper right component LB1//LB3 of the bridge circuit is indicated by L3. The lower right component of the bridge circuit is indicated by an inductor L21.

Focusing on the circuit on the left side of the bridge circuit of FIG. 9, the voltage across the voltage source VS12 is divided by the upper left and lower left inductors of the bridge circuit. That is, the voltage of L1/(L1+L2)×VS12 is applied to the upper left inductor of the bridge circuit. Since the input terminals T01 and T02 are at the ground potential in the radiation noise band, the potential of the nodes N01, N02, and N12 is indicated by that L1/(L1+L2)×VS12.

Next, focusing on the circuit on the right side of the bridge circuit, the voltage across the voltage source VS12 is divided by the inductors at the upper right and lower right of the bridge circuit. That is, the voltage of L3/(L3+L21)×VS12 is applied to the inductor at the upper right of the bridge circuit.

In this case, in the case of L1/(L1+L2)×VS12=L3/(L3+L21)×VS12, then the potential of the output terminal T11 becomes zero V. Since the ground potential is zero V, it means that no common mode voltage is generated. Therefore, when this condition is satisfied, a remarkable noise reduction effect is expected.

The above design conditional expression can be expressed by that L1:L2=L3:L21 in a form of inductance ratio. This is the impedance balance method. L01//L02+L11//L12 is paraphrased as an effective inductance between the input terminal T01 and the node N01 when the input terminal T01 and the input terminal T02 are short-circuited and the nodes N01 and N02 are short-circuited. Therefore, the above optimum condition will be described as follows. When (A) each of the inductances of the impedance elements A1 to A4 or the inductance of the bead is “2×L2”;
(B) the parallel inductance of the effective inductance between the input terminal T01 and the node N01, and the inductor L2 is L1 when the input terminal T01 and the input terminal T02 are short-circuited and the node N01 and the node N02 are short-circuited;
(C) each of the inductances of the impedance elements B1 to B4 or the inductance of the bead is “2×L3”; and
(D) the inductances of the inductors L21 and L22 are L4, then, the condition can be indicated by that L1:L2=L3:L4.

Although inferior to the above optimum conditions, the effect of noise reduction is expected even under the following conditions. The range in which the voltage applied to the upper right component of the bridge circuit of FIG. 9 is, for example, 0.5 to 1.5 times the voltage applied to the upper left component of the bridge circuit will be considered.

$$At 0.5 times , L 1 / ( L 1 + L 2 ) \times VS 12 = 0.5 \times L 3 / ( L 3 + L 21 ) \times VS 12. \qquad ( 1 )$$

$$At 1.5 times , L 1 / ( L 1 + L 2 ) \times VS 12 = 1.5 \times L 3 / ( L 3 + L 21 ) \times VS 12. \qquad ( 2 )$$

Therefore, in the equation of L1/(L1+L2)×VS12=ax L3/(L3+L21)×VS12, that is, in the equation of L1/(L1+L2)=ax L3/(L3+L21), when the coefficient “a” is 0.5≤a≤1.5 (when each element value is set in this manner and the equation is established), the noise reduction effect is expected.

In the first embodiment of FIG. 2, no impedance element is connected between the element terminals of the switch element S1 (in the case of a MOS transistor, between the drain and the source, and in the case of an IGBT, between the collector and the emitter), and the impedance element A1 and the impedance element B1 are connected between the terminals of the switch element S2. On the other hand, in the modification of FIG. 7, the impedance element A3 and the impedance element B3 are connected between the element terminals of the switch element S1 (in the case of a MOS transistor, between the drain and the source, and in the case of an IGBT, between the collector and the emitter), and the impedance element A1 and the impedance element B1 are connected between the element terminals of the switch element S2. Therefore, the elements connected to the high-side switching elements S1 and S3 and the elements connected to the low-side switching elements S2 and S4 are equalized, so that the switching times are almost the same. This makes it possible to make the switching loss uniform and to facilitate control design such as dead time adjustment.

In the electric power converter circuit apparatus of FIG. 7, the impedances of the impedance elements A1 to A4 and B1 to B4 are preferably set to be substantially equal to each other.

### Second Embodiment

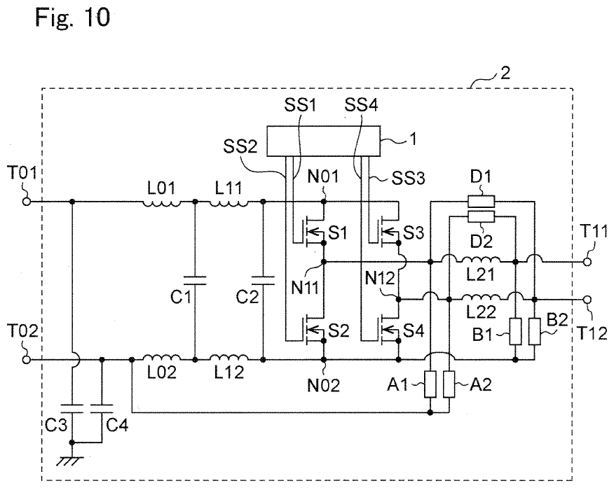

FIG. 10 is a circuit diagram showing a configuration example of an electric power converter circuit apparatus according to a second embodiment. The electric power converter circuit apparatus of FIG. 10 is different from the electric power converter circuit apparatus of FIG. 2 in the following point:
(1) impedance elements D1 and D2 are further included.

Differences will be described below.

Referring to FIG. 10, the impedance element D1 is connected between the node N11 and the output terminal T12, and the impedance element D2 is connected between the node N12 and the output terminal T11.

In the second embodiment of FIG. 10 configured as described above, a larger noise reduction effect can be obtained as compared with the first embodiment. The principle thereof will be described below.

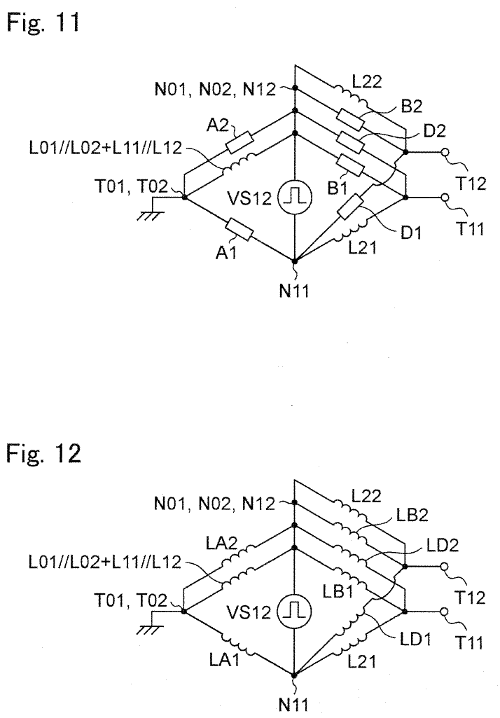

FIG. 11 is an equivalent circuit diagram in a radiation noise band of the electric power converter circuit apparatus of FIG. 10. In a manner similar to that of the first embodiment, in the radiation noise band, impedances of capacitors C1 to C4 are sufficiently smaller than those of other elements, and thus can be approximated to a short circuit. However, in order to focus on noise propagation from a pair of elements S1 and S2 of the first phase, the voltages of the pair of switch elements S1 and S2 are represented by the voltage source VS12, and a pair of switch elements S3 and S4 of the second phase are regarded as short-circuited.

As is apparent from FIG. 11, the impedance elements A1 and B1 are added from the voltage source VS12 to the first-phase output terminal T11, and this configures the bridge circuit. Therefore, noise propagation from the voltage source VS12 to the output terminal T11 can be reduced by the impedance balance method. As a result, it is possible to suppress the common mode current propagating in the wiring extending from the output terminal T11, and it is possible to reduce the cost and reduce the size and weight by reducing the radiation noise and reducing the number of countermeasure components.

Furthermore, impedance elements A1 and D1 are added from the voltage source VS12 to the output terminal T12 of the second phase, and this configures the bridge circuit. Therefore, noise propagation from the voltage source VS12 to the output terminal T12 can also be reduced by the impedance balance method. Similarly, noise propagation from the pair of switch elements S3 and S4 of the second phase to the output terminals T11 and T12 can also be reduced. As a result, it is possible to further suppress the common mode current propagating in the wiring extending from the output terminals T11 and T12, and it is possible to further reduce the cost and reduce the size and weight by reducing the radiation noise and reducing the number of countermeasure components.

As means for realizing the impedance elements A1, A2, B1, B2, D1, and D2, a series circuit of an inductor and a capacitor will be considered. For example, when the impedance element A1 is shown in a circuit diagram, the impedance element A1 is shown as in, for example, FIG. 4. The same applies to the impedance elements A2, B1, B2, D1, and D2. In this case,
(1) the impedance element D1 is represented by, for example, a series circuit of a capacitor CD1 and an inductor LD1; and
(2) the impedance element D2 is represented by, for example, a series circuit of a capacitor CD2 and an inductor LD2.

In the impedance element A1, due to the presence of the capacitor CA1, the terminals of the impedance element are insulated from each other in terms of direct current, so that generation of a PWM voltage similar to that of the inverter circuit according to First Comparative Example can be realized. Furthermore, in the radiation noise band, the impedance of the capacitor CA1 is smaller than that of other elements, and thus can be approximated to a short-circuit state. Therefore, the impedance of the inductor LA1 is dominant in the radiation noise band. At this time, the equivalent circuit of FIG. 11 can be specifically represented as in FIG. 12.

FIG. 12 is an equivalent circuit diagram in a radiation noise band of the electric power converter circuit apparatus of FIG. 10. As is apparent from FIG. 12, since the components of the bridge circuit are configured by only inductors, a large noise reduction effect can be obtained in a wide band by the impedance balance method. It also facilitates the designing.

In order to make the impedance of the inductor LA1 dominant in the radiation noise band as described above, it is necessary to design the series resonance frequency of the capacitor CA1 and the inductor LA1 to be equal to or less than the radiation noise band.

In this case, as shown in FIGS. 4B to 4D, a resister element may be further added to the impedance elements A1, A2, B1, B2, D1, and D2 in series or in parallel with the inductor. As a result, the impedance at the self-resonance frequency of the impedance elements can be stabilized, and occurrence of noise peaks can be avoided. That is, the noise reduction effect can be obtained in a wide band. As the impedance elements A1, A2, B1, B2, D1, and D2 each including the inductor, a ferrite beads BD1 may be used. The equivalent circuit of the ferrite bead BD1 is generally represented by, for example, a circuit (FIG. 4E) in which another resistor R2 is connected in series to a parallel circuit of the inductor LA1 and the resistor R1. As described above, when the ferrite bead BD1 is used, since the resistance component is contained, the noise reduction effect can be stably obtained without using the resister element.

Next, conditions for maximizing the noise reduction effect will be described.

In the equivalent circuit of FIG. 12, first of all, the bridge with respect to the output terminal T11 will be considered. The upper left component of the bridge circuit with respect to the input terminal T11 is represented by LA2//(L01//L02+L11//L12). The inductance of this combined inductors is indicated by L1. The lower left component of the bridge circuit is indicated by LA1. The upper right component LB1//LD2 of the bridge circuit is indicated by L3a. The lower right component of the bridge circuit is indicated by L21. Focusing on the circuit on the left side of the bridge circuit, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of the nodes N01, N02, and N12 is indicated by that L1/(L1+LA1)×VS12.

Next, focusing on the circuit on the right side of the bridge circuit, the voltage across the voltage source VS12 is divided by the inductors at the upper right and lower right of the bridge circuit. That is, the voltage of L3a/(L3a+L21)×VS12 is applied to the inductor at the upper right of the bridge circuit. In the case of L1/(L1+LA1)×VS12=L3a/(L3a+L21)×VS12, then the potential of the output terminal T11 becomes zero V. Since the ground potential is zero V, it means that no common mode voltage is generated. Therefore, when this condition is satisfied, a remarkable noise reduction effect is expected.

Next, in the equivalent circuit of FIG. 12, a bridge circuit for the output terminal T12 will be considered.

The upper left and lower left components of the bridge circuit with respect to the input terminal T12 are the same as those of the bridge circuit with respect to the input terminal T11. The upper right component L22//LB2 of the bridge circuit is indicated by L3b. The lower right component of the bridge circuit is indicated by LD1. Focusing on the circuit on the left side of the bridge circuit, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of the nodes N01 and N02 is indicated by that L1/(L1+LA1)×VS12.

Next, focusing on the circuit on the right side of the bridge circuit, the voltage across the voltage source VS12 is divided by the inductors at the upper right and lower right of the bridge circuit. That is, the voltage of L3b/(L3b+LD1)×VS12 is applied to the upper right inductor. In the case of that L1/(L1+LA1)×VS12=L3b/(L3b+LD1)×VS12, then the potential of the output terminal T12 becomes zero V. Since the ground potential is zero V, it means that no common mode voltage is generated. Therefore, when this condition is satisfied, a remarkable noise reduction effect is expected.

In this case, when the inductances L21 and L22 of the output wiring are equal to the inductances of the impedance elements D1 and D2 or the inductances LD1 and LD2 of the beads, the above two conditions become equal to each other. That is, due to the voltage source VS12, no common mode voltage is generated at both the output terminal T11 and the output terminal T12. Similarly, due to the voltage source VS34, no common mode voltage is generated at both the output terminal T11 and the output terminal T12. While the first embodiment suppresses noise propagation from the switch elements S1 to S4 to the output terminal T11 or T12 of the own phase, the second embodiment can simultaneously suppress noise propagation from the switch elements S1 to S4 not only to the output terminal T11 or T12 of the own phase but also to the output terminal T12 or T11 of another phase.

The above design conditional expression can be expressed by that L1:LA1=L3a:L21 or L1:LA1=L3b:LD1 in a form of inductance ratio. This is the impedance balance method. L01//L02+L11//L12 is rephrased as an effective inductance between the input terminal T01 and the node N01 when the input terminal T01 and the input terminal T02 are short-circuited and the node N01 and the node N02 are short-circuited.

Therefore, the above optimum condition will be described as follows. When (A) each of the inductances of the impedance elements A1 and A2 or the inductance of the bead is L2;
(B) the parallel inductance of the effective inductance between the input terminal T01 and the node N01, and the inductor L2 is L1 when the input terminal T01 and the input terminal T02 are short-circuited and the nodes N01 and N02 are short-circuited;
(C) the parallel inductance of the inductance of the inductor of the impedance element B1 or B2 and the inductance of the inductor of the impedance element D1 or D2 is indicated by L3; and
(D) each of the inductances of the inductors L21 and L22 is L4, then, the condition can be indicated by that L4, L1:L2=L3:L4.

Although inferior to the above optimum conditions, the effect of noise reduction is expected even under the following conditions. The range in which the voltage applied to the upper right component of the bridge circuit of FIG. 12 is 0.5 to 1.5 times the voltage applied to the upper left component of the bridge circuit will be considered.

$$At 0.5 times , L 1 / ( L 1 + LA 1 ) \times VS 12 = 0.5 \times L 3 a / ( L 3 a + L 21 ) \times VS 12.$$

$$At 1.5 times , L 1 / ( L 1 + LA 1 ) \times VS 12 = 1.5 \times L 3 a / ( L 3 a + L 21 ) \times VS 12 .$$

Therefore, in the equation of L1/(L1+LA1)×VS12=ax L3a/(L3a+L21)×VS12, that is, in the equation of L1/(L1+LA1)=ax L3a/(L3a+L21), when the coefficient “a” is 0.5≤a≤1.5 (when each element value is set in this way and the equation is established), then the noise reduction effect is expected.

Furthermore, the effects of the second embodiment will be shown by circuit simulation. The circuit parameters are as follows. However, the parenthesis indicates parasitic components considered in series.

$$C 1 = 1 mF ( 10 nH , 10 m Ω ) ,$$

$$C 2 = 100 nF ( 1 nH , 10 m Ω ) ,$$

$$C 3 = C 4 = 4.7 nF ( 10 nH , 0.2 Ω ) ,$$

$$L 01 = L 02 = L 11 = L 12 = 0.5 μH ,$$

$$L 21 = L 22 = 0.5 μ H .$$

In addition, all of the impedance elements A1, A2, B1, B2, D1, and D2 are series circuits of 0.5 pH, 200 pF, and 30Ω. A DC voltage of 282 V is input between the input terminal T01 and the input terminal T02, and the switching frequency (carrier frequency) of the switch elements S1 to S4 is set to 12 kHz. The common mode currents in a case where a 5 m-long motor cable (T-type equivalent circuit) and a motor (winding inductance of 1 μH, parasitic capacitance between winding and housing of 0.5 nF) are connected to the output terminals T11 and T12 of the inverter circuit are compared.

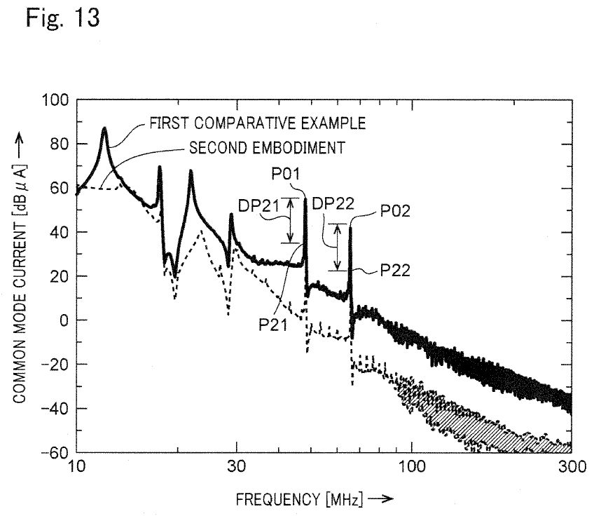

FIG. 13 is a spectrum diagram showing a comparison of common mode current suppression effects of the electric power converter circuit apparatus of FIGS. 1 and 10. As is apparent from FIG. 13, it can be confirmed that the suppression effect of about 20 dB is stably obtained in the radiation noise band. In particular, there are a suppression effect DP21 (=P01−P21) at about 50 MHz and a suppression effect DP22 (=P02−P22) at about 70 MHz. In this case, P01 and P02 are peaks of the common mode current of First Comparative Example, and P21 and P22 are peaks of the common mode current of the second embodiment.

The above embodiments or modification may be used in appropriate combination. For example, the impedance elements A3, A4, B3, and B4 described in the modification of the first embodiment may be added to the second embodiment. Also in this case, a similar noise suppression effect can be obtained.

As described above, in the electric power converter circuit apparatus of FIG. 10, the inductances of the inductors L21 and L22 and the inductances included in the impedance elements D1 and D2 are preferably set to be substantially equal to each other.

### Third Embodiment

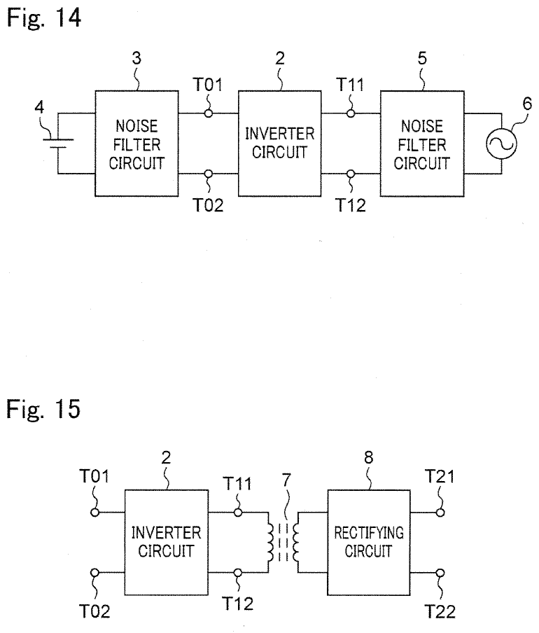

FIG. 14 is a circuit diagram showing a configuration example of an electric power converter circuit apparatus according to a third embodiment. In FIG. 14, the electric power converter circuit apparatus includes a noise filter circuit 3, an inverter circuit 2, and a noise filter circuit 5.

Referring to FIG. 14, the input terminals T01 and T02 of the inverter circuit 2 are connected to a DC power supply 4 via the noise filter circuit 3. The output terminals T11 and T12 of the inverter circuit 2 are connected to the AC power supply 6 (or an AC load) via the noise filter circuit 5.

The electric power converter circuit apparatus according to the third embodiment configured as described above is a single-phase DC-AC converter circuit that converts DC power and AC power into power in one direction or both directions. Therefore, by applying any of the above-described embodiments as the inverter circuit 2, the AC side common mode current of the single-phase DC-AC converter circuit can be suppressed. This makes it possible to reduce the radiation noise of the single-phase DC-AC converter circuit, reduce the cost by reducing the number of countermeasure components, and reduce the size and weight.

### Fourth Embodiment

FIG. 15 is a circuit diagram showing a configuration example of an electric power converter circuit apparatus according to a fourth embodiment. The electric power converter circuit of FIG. 15 includes an inverter circuit 2, an insulating transformer 7, and a rectifier circuit 8.

Referring to FIG. 15, output terminals T11 and T12 of the inverter circuit 2 are connected to the rectifier circuit 8 via the insulating transformer 7. In this case, the rectifier circuit 8 has output terminals T21 and T22.

The electric power converter circuit according to the fourth embodiment configured as described above is a DC-DC converter circuit that converts a DC voltage in one direction or in both directions. Therefore, by applying any of the above-described embodiments as the inverter circuit 2, the common mode current of the DC-DC converter circuit can be suppressed. This makes it possible to reduce the radiation noise of the DC-DC converter circuit, reduce the cost by reducing the number of countermeasure components, and reduce the size and weight.

### Second Comparative Example

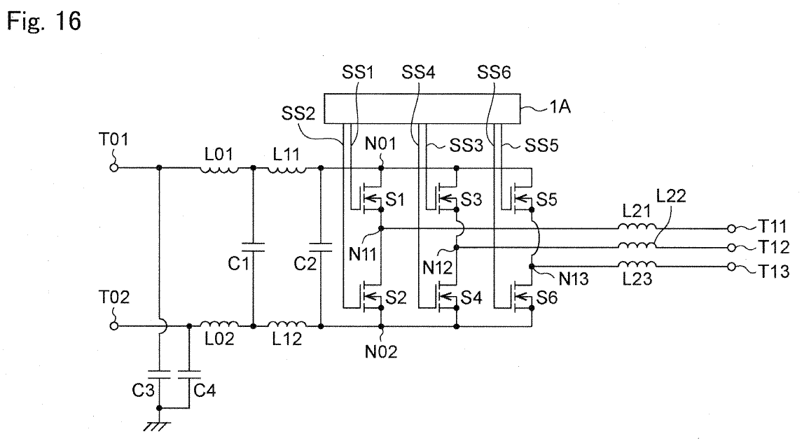

FIG. 16 is a circuit diagram showing a configuration of an electric power converter circuit apparatus according to a three-phase inverter circuit of Second Comparative Example. The electric power converter circuit apparatus of FIG. 16 is different from the electric power converter circuit apparatus of FIG. 1 in the following points:
(1) a controller circuit 1A for a three-phase inverter circuit is included instead of the controller circuit 1 for a two-phase inverter circuit; and
(2) switch elements S5 and S6, an inductor L23, and an output terminal T13 are further included.

Differences will be described below.

Referring to FIG. 16, the node N01 is connected to the node N02 via the drain and the source of the switch element S5 and the drain and the source of the switch element S6. The node N13, which is the connection point between the source of the switch element S5 and the drain of the switch element S6, is connected to the output terminal T13 via the inductor L23.

In this case, the DC voltage of DC power is input between the input terminal T01 and the input terminal T02. Capacitors C1 and C2 are X capacitors, for example, C1 is a smoothing capacitor, and C2 is a snubber capacitor. The capacitors C3 and C4 are Y capacitors for noise countermeasures. Inductors L01, L02, L11, L12, and L21 to L23 are wiring inductances or choke coils.

Switch elements S1 to S6 are, for example, N-channel MOS transistors, and the switch elements S1 to S6 constitute a full-bridge circuit. The controller circuit 1A generates known command signals SS1 to SS6 for performing PWM system switching (three phases) and outputs the command signals SS1 to SS6 to the gates of the switch elements S1 to S6, respectively. As a result, the switch elements S1 to S6 are switched on or off, and a desired PWM voltage is generated at output terminals T11, T12, and T13.

At this time, when a common mode current flowing through the inductors L21 to L23 in phase is generated and propagates from the output terminals T11 to T13 to, for example, a motor cable, radiation noise increases. In order to suppress the common mode current, it is necessary to take measures such as sandwiching the ferrite core in the motor cable, which causes additional cost and increases the size and weight of the equipment.

In view of the knowledge of these problems, the present inventors have devised an electric power converter circuit apparatus according to the following embodiments and modifications in order to solve the problems.

### Fifth Embodiment

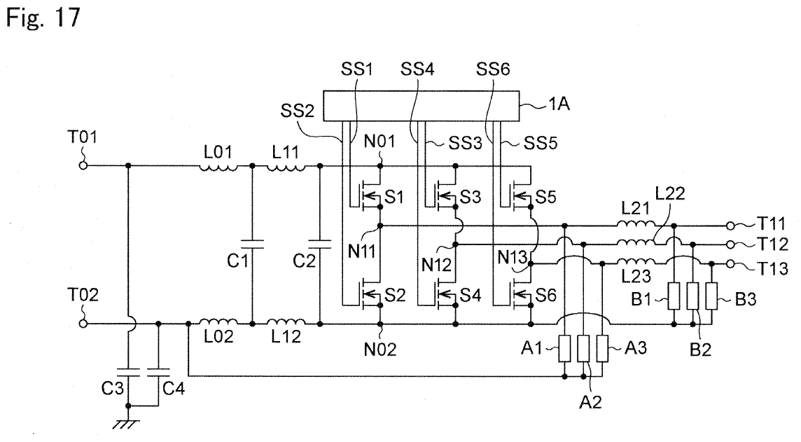

FIG. 17 is a circuit diagram showing a configuration example of an electric power converter circuit apparatus according to a fifth embodiment. The electric power converter circuit apparatus of FIG. 17 is different from the electric power converter circuit apparatus of FIG. 16 in the following point:
(1) impedance elements A1 to A3 and B1 to B3 are further included.

Differences will be described below.

Referring to FIG. 17, the node N11 is connected to the input terminal T02 via the impedance element A1, the node N12 is connected to the input terminal T02 via the impedance element A2, and the node N13 is connected to the input terminal T02 via the impedance element A3. In addition, the output terminal T11 is connected to the node N02 via the impedance element B1, the output terminal T12 is connected to the node N02 via the impedance element B2, and the output terminal T13 is connected to the node N02 via the impedance element B3.

According to the fifth embodiment configured as described above, in the frequency band of 30 MHz to 300 MHz (radiation noise band) in which the radiation noise becomes a problem, the impedance of the capacitors C1 to C4 becomes small, which can be approximated to a short circuit.

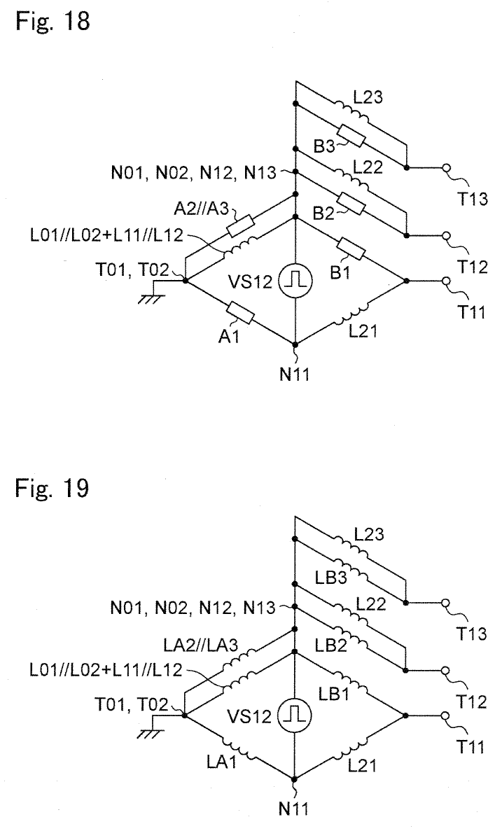

FIG. 18 is an equivalent circuit diagram in a radiation noise band of the electric power converter circuit apparatus of FIG. 17. In this case, in order to focus on noise propagation from the pair of switch elements S1 and S2 of the first phase, the voltages of the pair of switch elements S1 and S2 are represented by the voltage source VS12, and the pair of switch elements S3 and S4 of the second phase and the pair of switch elements S5 and S6 of the third phase are regarded as short-circuited. This can be considered as a short circuit except for the focused voltage source from the principle of superposition.

As is apparent from FIG. 18, the impedance elements A1 and B1 are added from the voltage source VS12 to the first-phase output terminal T11, and this configures the bridge circuit. Therefore, although the detailed principle will be described later, noise propagation from the voltage source VS12 to the output terminal T11 can be reduced by the impedance balance method. As a result, it is possible to suppress the common mode current propagating in the wiring extending from the output terminal T11, and it is possible to reduce the cost and reduce the size and weight by reducing the radiation noise and reducing the number of countermeasure components.

As means for realizing the impedance elements A1 to A3 and B1 to B3, a series circuit of an inductor and a capacitor will be considered. For example, when the impedance element A1 is shown in a circuit diagram, the impedance element A1 is shown as in FIG. 4A, and the impedance elements A2, A3 and B1 to B3 are similarly shown. Due to the presence of the capacitor CA1, the terminals of the impedance element are insulated from each other in terms of direct current, so that generation of a PWM voltage similar to that of the inverter circuit according to Second Comparative Example can be realized. Furthermore, in the radiation noise band, the impedance of the capacitor CA1 is sufficiently smaller than that of other elements, and thus can be approximated to a short circuit. Therefore, the impedance of the inductor LA1 is dominant in the radiation noise band. At this time, the equivalent circuit of FIG. 18 can be specifically represented as in FIG. 19.

FIG. 19 is an equivalent circuit diagram in a radiation noise band of the electric power converter circuit apparatus of FIG. 17. As is apparent from FIG. 19, since the components of the bridge circuit are only inductors, a large noise reduction effect can be obtained in a wide band by the impedance balance method. It also facilitates the designing.

In order to make the impedance of the inductor LA1 dominant in the radiation noise band as described above, it is necessary to design the series resonance frequency of the capacitor CA1 and the inductor LA1 to be equal to or less than the radiation noise band.

In this case, as shown in FIG. 4B or 4C, a resister element may be further added to the impedance elements A1 to A3 and B1 to B3 in series or in parallel with the inductor. As a result, the impedance at the self-resonance frequency of the impedance elements can be stabilized, and occurrence of noise peaks can be avoided. That is, the noise reduction effect can be obtained in a wide band. As the impedance elements A1 to A3 and B1 to B3 each including the inductor, a ferrite bead BD1 may be used. The equivalent circuit of the ferrite bead BD1 is generally represented by, for example, a circuit (FIG. 4E) in which another resistor R2 is connected in series to a parallel circuit of the inductor LA1 and the resistor R1. As described above, when the ferrite bead BD1 is used, since the resistance component is contained, the noise reduction effect can be stably obtained without using the resister element.

Next, conditions for maximizing the noise reduction effect will be described. In the equivalent circuit of FIG. 19, the upper left component of the bridge circuit with respect to the output terminal T11 is represented by LA2//LA3//(L01//L02+L11//L12). This combined inductance is indicated by L1. The lower left, upper right, and lower right components of the bridge circuit are inductors LA1, LB1, and L21 in this order. Focusing on the circuit on the left side of the bridge circuit, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of nodes N01 and N02 is indicated by that L1/(L1+LA1)×VS12.

Next, focusing on the circuit on the right side of the bridge circuit, the voltage across the voltage source VS12 is divided by the inductors at the upper right and lower right of the bridge circuit. That is, the voltage of LB1/(LB1+L21)×VS12 is applied to the inductor at the upper right of the bridge circuit. In this case, in the case of L1/(L1+LA1)×VS12=LB1/(LB1+L21)×VS12, then the potential of the output terminal T11 becomes zero V. Since the ground potential is zero V, it means that no common mode voltage is generated. Therefore, when this condition is satisfied, a remarkable noise reduction effect is expected.

The above design conditional expression can be expressed by that L1:LA1=LB1:L21 in a form of inductance ratio. This is the impedance balance method. L01//L02+L11//L12 is rephrased as an effective inductance between the input terminal T01 and the node N01 when the input terminal T01 and the input terminal T02 are short-circuited and the node N01 and the node N02 are short-circuited. Therefore, the above optimum condition will be described as follows. When (A) each of the inductances of the impedance elements A1 to A3 or the inductance of the bead is L2;
(B) the parallel inductance of the effective inductance between the input terminal T01 and the node N01, and the L2/2 is L1 when the input terminal T01 and the input terminal T02 are short-circuited and the node N01 and the node N02 are short-circuited;
(C) each of the inductances of the impedance elements B1 to B3 or the inductance of the bead is L3; and
(D) each of the inductances of the inductors L21 to L23 is L4, then the condition can be indicated by that L1:L2=L3:L4.

Although inferior to the above optimum conditions, the effect of noise reduction is expected even under the following conditions. The range in which the voltage applied to the upper right component of the bridge circuit of FIG. 19 is, for example, 0.5 to 1.5 times the voltage applied to the upper left component of the bridge circuit will be considered.

$$At 0.5 times , L 1 / ( L 1 + LA 1 ) \times VS 12 = 0.5 \times LB 1 / ( LB 1 + L 21 ) \times VS 12.$$

$$At 1.5 times , L 1 / ( L 1 + LA 1 ) \times VS 12 = 1.5 \times LB 1 / ( LB 1 + L 21 ) \times VS 12.$$

Therefore, in the equation of L1/(L1+LA1)×VS12=ax LB1/(LB1+L21)×VS12, that is, in the equation of L1/(L1+LA1)=ax LB1/(LB1+L21), when the coefficient “a” is 0.5≤a≤1.5 (when each element value is set in this way and the equation is established), then the noise reduction effect is expected.

The effects of the fifth embodiment will be shown by circuit simulation. The circuit parameters are as follows. However, the parenthesis indicates parasitic components considered in series.

$$C 1 = 1 mF ( 10 nH , 10 m Ω ) ,$$

$$C 2 = 100 nF ( 1 nH , 10 m Ω ) ,$$

$$C 3 = C 4 = 4.7 nF ( 10 nH , 0.2 Ω ) ,$$

$$L 01 = L 02 = L 11 = L 12 = 0.5 μH , and$$

$$L 21 = L 22 = 0.5 μ H .$$

In addition, the impedance elements A1 and A2 are series circuits of 0.5 μH, 200 pF, and 30Ω, and the impedance elements B1 and B2 are series circuits of 0.167 pH, 200 pF, and 30Ω. A DC voltage of 282 V is input between the input terminal T01 and the input terminal T02, and the switching frequency (carrier frequency) of the switch elements S1 to S6 is set to 12 kHz. The common mode currents in a case where a 5 m-long motor cable (T-type equivalent circuit) and a motor (winding inductance of 1 μH, parasitic capacitance between winding and housing of 0.5 nF) as a load are connected to the output terminals T11 to T13 of the inverter circuit are compared.

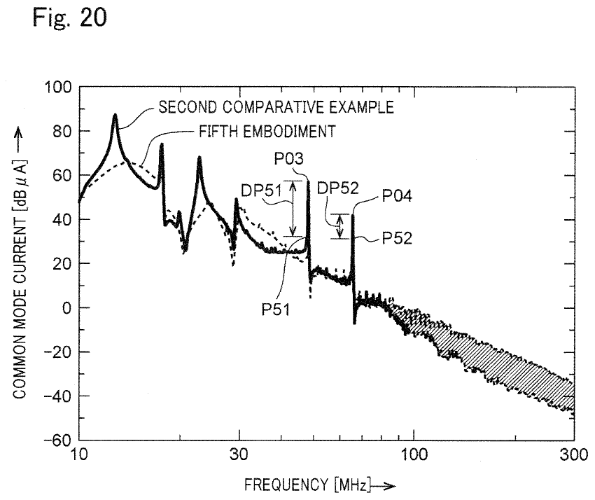

FIG. 20 is a spectrum diagram showing a comparison of common mode current suppression effects of the electric power converter circuit apparatus of FIGS. 16 and 17. As is apparent from FIG. 20, it can be confirmed that a suppression effect of 10 dB to 20 dB can be obtained at the noise peak that tends to cause a problem of the radiation noise band. In particular, there is a suppression effect DP51 (=P03−P51) at about 50 MHz and a suppression effect DP52 (=P03−P52) at about 70 MHz. In this case, P03 and P04 are peaks of the common mode current of Second Comparative Example, and P51 and P52 are peaks of the common mode current of the fifth embodiment.

### Sixth Embodiment

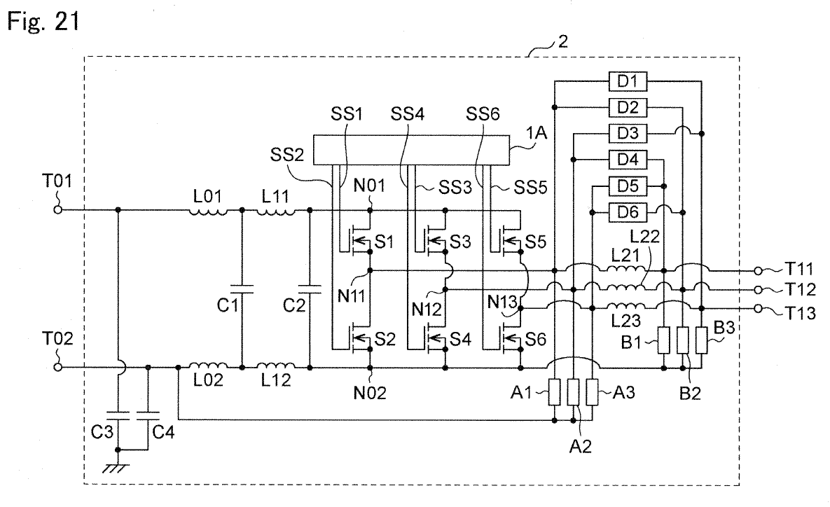

FIG. 21 is a circuit diagram showing a configuration example of an electric power converter circuit apparatus according to a sixth embodiment. The electric power converter circuit apparatus of FIG. 21 is different from the electric power converter circuit apparatus of FIG. 17 in the following points:
(1) impedance elements D1 to D6 are further included.

Differences will be described below.

Referring to FIG. 21, the node N11 is connected to the output terminal T13 via the impedance element D1, the node N11 is connected to the output terminal T12 via the impedance element D2, and the node N12 is connected to the output terminal T13 via the impedance element D3. In addition, the node N12 is connected to the output terminal T11 via the impedance element D4, the node N13 is connected to the output terminal T11 via the impedance element D5, and the node N13 is connected to the output terminal T12 via the impedance element D6.

According to the sixth embodiment configured as described above, a larger noise reduction effect can be obtained as compared with the fifth embodiment. The principle thereof will be described below.

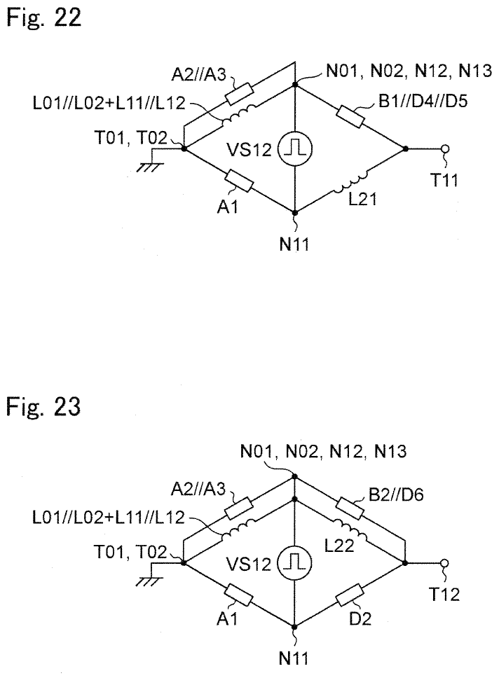

In the radiation noise band, impedances of capacitors C1 to C4 are sufficiently smaller than those of other elements, and thus can be approximated to a short circuit. Consider the equivalent circuit of FIG. 21 in the radiation noise band. In order to focus on noise propagation from the pair of switch elements S1 and S2 of the first phase, the voltages of the pair of switch elements S1 and S2 are represented by the voltage source VS12, and the pair of switch elements S3 and S4 of the second phase and the pair of switch elements S5 and S6 of the third phase are regarded as short-circuited. At this time, since the entire equivalent circuit becomes complicated, an equivalent circuit (bridge circuit) for the output terminal T11 is shown in FIG. 22, and an equivalent circuit for the output terminal T12 is shown in FIG. 23.

FIGS. 22 and 23 are equivalent circuit diagrams in the radiation noise band of the electric power converter circuit apparatus of FIG. 21 with respect to the output terminals T11 and T12, respectively. The equivalent circuit for the output terminal T13 is similar to the equivalent circuit for the output terminal T12. That is, it is classified into an equivalent circuit for the output terminal of the own phase and an equivalent circuit for the output terminal of the other phase.

As is apparent from FIG. 22, impedance elements A1 and B1 are added from the voltage source VS12 to the first-phase output terminal T11, and this configures the bridge circuit. Therefore, noise propagation from the voltage source VS12 to the output terminal T11 can be reduced by the impedance balance method. As a result, it is possible to suppress the common mode current propagating in the wiring extending from the output terminal T11, and it is possible to reduce the cost and reduce the size and weight by reducing the radiation noise and reducing the number of countermeasure components.

Furthermore, as is apparent from FIG. 23, the impedance elements B2 and D2 are added from the voltage source VS12 to the second-phase output terminal T12, and this configures the bridge circuit. Therefore, noise propagation from the voltage source VS12 to the output terminal T12 can also be reduced by the impedance balance method. As a result, it is possible to further suppress the common mode current propagating beyond the output terminal, and it is possible to further reduce the cost and reduce the size and weight by reducing the radiation noise and reducing the number of countermeasure components.

As means for realizing the impedance elements A1 to A3, B1 to B3, and D1 to D6, a series circuit of an inductor and a capacitor will be considered. For example, when the impedance element A1 is shown in a circuit diagram, for example, the impedance element A1 is shown as in FIG. 4A, and the impedance elements A2, A3, B1 to B3, and D1 to D6 are similarly shown. In this case,
(1) the impedance element D3 is represented by, for example, a series circuit of a capacitor CD3 and an inductor LD3; and
(2) the impedance element D4 is represented by, for example, a series circuit of a capacitor CD4 and an inductor LD4.

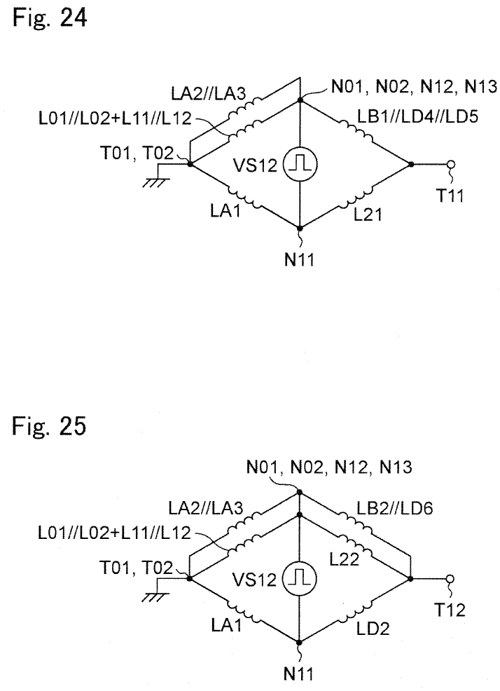

In the impedance element A1, due to the presence of the capacitor CA1, the terminals of the impedance element are insulated from each other in terms of direct current, so that generation of a PWM voltage similar to that of the inverter circuit according to Second Comparative Example can be realized. Furthermore, in the radiation noise band, the impedance of the capacitor CA1 is smaller, and thus can be approximated to a short circuit. Therefore, the impedance of the inductor LA1 is dominant in the radiation noise band. At this time, the equivalent circuits in FIGS. 22 and 23 can be specifically expressed in a manner similar to that of FIGS. 24 and 25, respectively.

FIGS. 24 and 25 are equivalent circuit diagrams in the radiation noise band of the electric power converter circuit apparatus with respect to the output terminals T11 and T12, respectively. As is apparent from FIGS. 24 and 25, since the components of the bridge circuit are only inductors, a large noise reduction effect can be obtained in a wide band by the impedance balance method. It also facilitates the designing.

In order to make the impedance of the inductor LA1 dominant in the radiation noise band as described above, it is necessary to design the series resonance frequency of the capacitor CA1 and the inductor LA1 to be equal to or less than the radiation noise band.

In this case, as shown in FIG. 4B or 4C, a resister element may be further added to the impedance elements A1 to A3, B1 to B3, and D1 to D6 in series or in parallel with the inductor. As a result, the impedance at the self-resonance frequency of the impedance elements can be stabilized, and occurrence of noise peaks can be avoided. That is, the noise reduction effect can be obtained in a wide band. As the impedance elements A1 to A3, B1 to B3, and D1 to D6 each including the inductor, the ferrite bead BD1 in FIG. 4D may be used. The equivalent circuit of the ferrite bead BD1 is generally represented by, for example, a circuit (FIG. 4E) in which another resistor R2 is connected in series to a parallel circuit of the inductor LA1 and the resistor R1. As described above, when the ferrite bead BD1 is used, since the resistance component is contained, the noise reduction effect can be stably obtained without using the resister element.

Next, the conditions for maximizing the noise reduction effect will be described.

First, the equivalent circuit of FIG. 24, that is, the bridge with respect to the output terminal T11 will be considered. The upper left component of the bridge circuit with respect to T11 is represented by LA2//LA3//(L01//L02+L11//L12). The inductance of this combined inductors is indicated by L1. The lower left component of the bridge circuit is indicated by LA1. The upper right component LB1//LD4//LD5 of the bridge circuit is indicated by L3a. The lower right component of the bridge circuit is indicated by L21. Focusing on the circuit on the left side of the bridge circuit, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of nodes N01 and N02 becomes L1/(L1+LA1)×VS12.

Next, focusing on the circuit on the right side of the bridge circuit, the voltage across the voltage source VS12 is divided by the inductors at the upper right and lower right of the bridge circuit. That is, the voltage of L3a/(L3a+L21)×VS12 is applied to the inductor at the upper right of the bridge circuit. In the case of L1/(L1+LA1)×VS12=L3a/(L3a+L21)×VS12, then the potential of the output terminal T11 becomes zero V. Since the ground potential is zero V, it means that no common mode voltage is generated. Therefore, when this condition is satisfied, a remarkable noise reduction effect is expected.

Next, the equivalent circuit of FIG. 25, that is, the bridge with respect to the output terminal T12 will be considered. The upper left and lower left components of the bridge circuit with respect to T12 are the same as those of the bridge circuit with respect to T11. The upper right component L22//LB2//LD6 of the bridge circuit is indicated by L3b. The lower right component of the bridge circuit is indicated by LD2. Focusing on the circuit on the left side of the bridge circuit, the voltage across the voltage source VS12 is divided by the upper left and lower left inductors of the bridge circuit. That is, the voltage of L1/(L1+LA1)×VS12 is applied to the upper left inductor of the bridge circuit. Since the input terminals T01 and T02 are at the ground potential in the radiation noise band, the potential of the nodes N01 and N02 becomes L1/(L1+LA1)×VS12.

Next, focusing on the circuit on the right side of the bridge circuit, the voltage across the voltage source VS12 is divided by the inductors at the upper right and lower right of the bridge circuit. That is, the voltage of L3b/(L3b+LD2)×VS12 is applied to the inductor at the upper right of the bridge circuit. In the case of L1/(L1+LA1)×VS12=L3b/(L3b+LD2)×VS12, then the potential of the output terminal T12 becomes zero V. Since the ground potential is zero V, it means that no common mode voltage is generated. Therefore, when this condition is satisfied, a remarkable noise reduction effect is expected.

In this case, when the inductances L21 to L23 of the output wiring are equal to the inductances of the impedance elements D1 to D6 or the inductances LD1 to LD6 of the beads, the above two conditions becomes equal to each other. That is, due to the voltage source VS12, no common mode voltage is generated at neither the output terminal T11 nor T12 (nor T13). In a similar manner to above, due to the voltage source VS34, no common mode voltage is generated at the output terminal T11, the output terminal T12, or the output terminal T13. The same applies to the voltage source VS56. While the fifth embodiment suppresses noise propagation from the switch element to the output terminal of the own phase, the sixth embodiment can simultaneously suppress noise propagation from the switch element to the output terminal of the other phase as well as the own phase.

The above design conditional expression can be expressed by that L1:LA1=L3a:L21 or L1:LA1=L3b:LD2 in a form of inductance ratio. This is the impedance balance method. L01//L02+L11//L12 is rephrased as an effective inductance between the input terminal T01 and the node N01 when the input terminal T01 and the input terminal T02 are short-circuited and the node N01 and the node N02 are short-circuited.

Therefore, the above optimum condition will be described as follows. When (A) each of the inductances of the impedance elements A1 to A3 or the inductance of the bead is L2;
(B) the parallel inductance of the effective inductance between the input terminal T01 and the node N01, and L2/2 is L1 when the input terminal T01 and the input terminal T02 are short-circuited and the node N01 and the node N02 are short-circuited;
(C) the parallel inductance of half the inductance of the inductors of the impedance elements B1 to B3 and the inductance of the inductors of the impedance elements D1 to D6 is L3; and
(D) the inductances of the inductors L21 to L23 are L4, then the condition can be indicated by that L1:L2=L3:L4.

In this case, the range in which the voltage applied to the upper right component of the bridge circuit is, for example, 0.5 to 1.5 times the voltage applied to the upper left component of the bridge circuit will be considered.

$$At 0.5 times , L 1 / ( L 1 + LA 1 ) \times VS 12 = 0.5 \times L 3 a / ( L 3 a + L 21 ) \times VS 12.$$

$$At 1.5 times , L 1 / ( L 1 + LA 1 ) \times VS 12 = 1.5 \times L 3 a / ( L 3 a + L 21 ) \times VS 12 .$$

Therefore, in the equation of L1/(L1+LA1)×VS12=ax L3a/(L3a+L21)×VS12, that is, in the equation of L1/(L1+LA1)=ax L3a/(L3a+L21), when the coefficient “a” is 0.5≤a≤1.5 (when each element value is set in this way and the equation is established), the noise reduction effect is expected.

The effects of the sixth embodiment will be shown using circuit simulation. The circuit parameters are as follows. However, the parenthesis indicates parasitic components considered in series.

$$C 1 = 1 mF ( 10 nH , 10 m Ω ) ,$$

$$C 2 = 100 nF ( 1 nH , 10 m Ω ) ,$$

$$C 3 = C 4 = 4.7 nF ( 10 nH , 0.2 Ω ) ,$$

$$L 01 = L 02 = L 11 = L 12 = 0.5 μH , and$$

$$L 21 = L 22 = 0.5 μ H .$$

In addition, all of the impedance elements A1 to A3, B1 to B3, and D1 to D6 are series circuits of 0.5 pH, 200 pF, and 30Ω. A DC voltage of 282 V is input between the input terminal T01 and the input terminal T02, and the switching frequency (carrier frequency) of the switch elements S1 to S6 is set to 12 kHz. The common mode currents in a case where a 5 m-long motor cable (T-type equivalent circuit) and a motor (winding inductance of 1 pH, parasitic capacitance between winding and housing of 0.5 nF) as a load are connected to the output terminals T11 to T13 of the inverter circuit are compared.

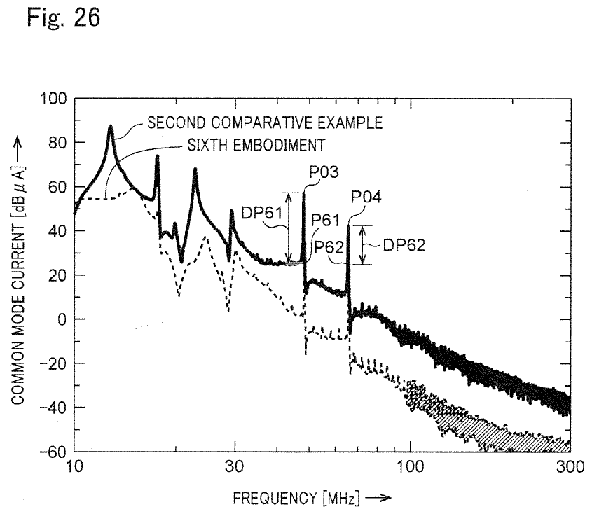

FIG. 26 is a spectrum diagram showing a comparison of common mode current suppression effects of the electric power converter circuit apparatus of FIGS. 16 and 21. As is apparent from FIG. 26, it can be confirmed that the suppression effect of about 20 dB is stably obtained in the radiation noise band. In particular, there is a suppression effect DP61 (=P03−P61) at about 50 MHz and a suppression effect DP62 (=P03−P62) at about 70 MHz. In this case, P03 and P04 are peaks of the common mode current of Second Comparative Example, and P61 and P62 are peaks of the common mode current of the sixth embodiment.

### Seventh Embodiment

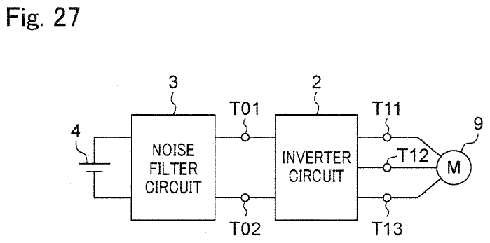

FIG. 27 is a circuit diagram showing a configuration example of an electric power converter circuit apparatus (system) according to a seventh embodiment. In FIG. 27, the electric power converter circuit apparatus includes a noise filter circuit 3 and an inverter circuit 2.

Referring to FIG. 27, the input terminals T01 and T02 of the inverter circuit 2 are connected to the DC power supply 4 via the noise filter circuit 3. The output terminals T11 to T13 of the inverter circuit 2 are connected to, for example, a three-phase motor 9 as a load example.

The electric power converter circuit apparatus according to the seventh embodiment is a three-phase motor inverter device that drives a three-phase motor using DC power. Therefore, by applying any of the above-described embodiments as the inverter circuit 2, the motor-side common mode current of the three-phase motor inverter device can be suppressed. This makes it possible to reduce the radiation noise of the three-phase motor inverter device, reduce the cost by reducing the number of countermeasure components, and reduce the size and weight.

In the seventh embodiment, the DC power supply 4 may include an AC power supply and a rectifier circuit. At this time, the connection order of the rectifier circuit and the noise filter circuit 3 may be switched. That is, the DC power supply 4 may be connected to the input terminal of the noise filter circuit 3, the output terminal of the noise filter circuit 3 may be connected to the input terminal of the rectifier circuit, and the output circuit of the rectifier circuit may be connected to the input terminals T01 and T02. In this case, the three-phase motor inverter device drives a three-phase motor using AC power. Therefore, by applying any of the above-described embodiments as the inverter circuit 2, the motor-side common mode current of the three-phase motor inverter device using AC power can be suppressed. This makes it possible to reduce the radiation noise of the three-phase motor inverter device using AC power, reduce the cost by reducing the number of countermeasure components, and reduce the size and weight.

### Other Modifications

In the above embodiments and modification, the ferrite bead BD1 is used, but the present disclosure is not limited thereto, and other types of beads such as chip beads may be used.

### INDUSTRIAL APPLICABILITY

The electric power converter circuit apparatus according to the present disclosure is useful for realizing an electric power converter circuit apparatus used in an in-vehicle device, an industrial device, and the like with low noise, small size, and low cost.

EXPLANATION OF REFERENCES

| | |
|---|---|
| 1 and 1A | Controller circuit |
| 2 | Inverter circuit |
| 3 and 5 | Noise filter circuit |
| 4 | DC power supply |
| 6 | AC power supply |
| 7 | Insulating transformer |
| 8 | Rectifier circuit |
| 9 | Motor |
| A1 to A4, B1 to B4, | Impedance element |
| and D1 to D6 | |
| BD1 | Ferrite bead |
| C1 to C4, and CA1 | Capacitor |
| L01 to L23, LA1 to LA4, | Inductor |
| LB1 to LB4, and LD1 to LD6 | |
| N01 to N13 | Node |
| R1 to R2 | Resistor |
| S1 to S6 | Switch element |
| T01 to T02 | Input terminal |
| T11 to T13, and | Output terminal |
| T21 to T22 | |
| VS12 | Voltage source |

1. An electric power converter circuit apparatus comprising an inverter circuit including a bridge circuit, the inverter circuit provided between first and second input terminals and first and second output terminals,
wherein the bridge circuit is configured by connecting in parallel: a first series circuit including first and second switch elements connected in series to each other; and a second series circuit including third and fourth switch elements connected in series to each other,
wherein both ends of the first series circuit and both ends of the second series circuit are defined as first and second connection points, respectively, and are connected to the first and second input terminals via first and second inductances,
wherein a third connection point of the first and second switch elements is connected to the first output terminal via a third inductance,
wherein a fourth connection point of the third and fourth switch elements is connected to the second output terminal via a fourth inductance, and
wherein the electric power converter circuit apparatus comprises:
a first impedance element connected between the third connection point and the first or second input terminal;
a second impedance element connected between the fourth connection point and the first or second input terminal;
a third impedance element connected between the first output terminal and the first or second input terminal; and
a fourth impedance element connected between the second output terminal and the first or second input terminal.

2. The electric power converter circuit apparatus as claimed in claim 1,
wherein each of the first to fourth impedance elements includes any of:
(1) a third series circuit of an inductor and a capacitor;
(2) a circuit further including a resistor in series or in parallel with the inductor in the third series circuit; and
(3) a fourth series circuit of a bead and a capacitor.

3. The electric power converter circuit apparatus as claimed in claim 1,
wherein each of inductances included in the first and second impedance elements is L2,
wherein a parallel inductance of an effective inductance between the first input terminal and the first connection point, and the inductance L2 is L1 when the first and second input terminals are short-circuited and the first and second connection points are short-circuited,
wherein each of inductances included in the third and fourth impedance elements is L3,
wherein each of inductances included in the third and fourth inductances is L4, and
wherein the inductances L1 to L4 are set such that L1:L2=L3:L4.

4. The electric power converter circuit apparatus as claimed in claim 1,
wherein an inductance included in the first impedance element is L2,
wherein a parallel inductance of an effective inductance between the first input terminal and the third connection point, and the inductance L2 is L1 when the first and second input terminals are short-circuited and the third and fourth connection points are short-circuited is L1,
wherein an inductance included in the third impedance element is L3,
wherein each of the third and fourth inductances is L4, and
wherein the inductances L1 to L4 are set such that a coefficient “a” satisfies 0.5≤a≤1.5 in the following equation:
$$L 1 ( L 1 + L 2 ) = a \times L 3 / ( L 3 + L 4 ) .$$

5. The electric power converter circuit apparatus as claimed in claim 1, further comprising:
a fifth impedance element connected between the first input terminal and the third connection point; and
a sixth impedance element connected between the first input terminal and the fourth connection point;
a seventh impedance element connected between the first connection point and the first output terminal; and
an eighth impedance element connected between the first connection point and the second output terminal.

6. The electric power converter circuit apparatus as claimed in claim 5,
wherein impedances of the first, second, fifth, and sixth impedance elements are substantially equal to each other, and
wherein impedances of the third, fourth, seventh, and eighth impedance elements are substantially equal to each other.

7. The electric power converter circuit apparatus as claimed in claim 5,
wherein each of inductances included in the first and second impedance elements and the fifth and sixth impedance elements is 2×L2,
wherein a parallel inductance of an effective inductance between the first input terminal and the first connection point, and the inductance L2 is L1 when the first and second input terminals are short-circuited and the first and second connection points are short-circuited,
wherein each of inductances included in the third and fourth impedance elements and the seventh and eighth impedance elements is 2×L3, and
wherein each of the third and fourth inductances is L4, and
wherein the inductances L1 to L4 are set such that L1:L2=L3:L4.

8. The electric power converter circuit apparatus as claimed in claim 5,
wherein each of inductances included in the first and second impedance elements and the fifth and sixth impedance elements is 2× L2,
wherein a parallel inductance of an effective inductance between the first input terminal and the first connection point, and the inductance L2 is L1 when the first and second input terminals are short-circuited and the first and second connection points are short-circuited,
wherein each of inductances included in the third and fourth impedance elements and the seventh and eighth impedance elements is 2×L3,
wherein each of the third and fourth inductances is L4, and
wherein the inductances L1 to L4 are set such that a coefficient “a” satisfies 0.5≤a≤1.5 in the following equation:
$$L 1 ( L 1 + L 2 ) = a \times L 3 / ( L 3 + L 4 ) .$$

9. The electric power converter circuit apparatus as claimed in claim 1, further comprising:
a ninth impedance element connected between the third connection point and the second output terminal; and
a tenth impedance element connected between the fourth connection point and the first output terminal.

10. The electric power converter circuit apparatus as claimed in claim 9,
wherein each of the ninth and tenth impedance elements includes any of:
(1) a fifth series circuit of an inductor and a capacitor;
(2) a circuit further including a resistor in series or in parallel with the inductor in the fifth series circuit; and
(3) a sixth series circuit of a bead and a capacitor.

11. The electric power converter circuit apparatus as claimed in claim 9,
wherein the third and fourth inductances and inductances included in the ninth and the tenth impedance elements are substantially equal to each other.

12. The electric power converter circuit apparatus as claimed in claim 9,
wherein each of inductances included in the first and second impedance elements is L2,
wherein a parallel inductance of an effective inductance between the first input terminal and the first connection point, and the inductance L2 is L1 when the first and second input terminals are short-circuited and the first and second connection points are short-circuited,
wherein a parallel inductance of each of inductances included in the third and fourth impedance elements, and each of inductances included in the ninth and tenth impedance elements is L3, and
wherein each of the third and fourth inductances is L4, and
wherein the inductances L1 to L4 are set such that L1:L2=L3:L4.

13. The electric power converter circuit apparatus as claimed in claim 9,
wherein each of inductances included in the first and second impedance elements is L2,
wherein a parallel inductance of an effective inductance between the first input terminal and the first connection point, and the inductance L2 is L1 when the first and second input terminals are short-circuited and the first and second connection points are short-circuited,
wherein a parallel inductance of each of inductances included in the third and fourth impedance elements, and each of inductances included in the ninth and tenth impedance elements is L3,
wherein each of the third and fourth inductances are is L4, and
wherein the inductances L1 to L4 are set such that a coefficient “a” satisfies 0.5≤a≤1.5 in the following equation:
$$L 1 ( L 1 + L 2 ) = a \times L 3 / ( L 3 + L 4 ) .$$

14. The electric power converter circuit apparatus as claimed in claim 1, further comprising:
a first noise filter circuit connected to first and second input terminals of the electric power converter circuit apparatus; and
a second noise filter circuit connected to first and second output terminals of the electric power converter circuit apparatus.

15. The electric power converter circuit apparatus as claimed in claim 1, further comprising:
an insulating transformer having input terminals connected to the first and second output terminals of the electric power converter circuit apparatus; and
a rectifier circuit connected to an output terminal of the insulating transformer.

16. An electric power converter circuit apparatus including an inverter circuit including a bridge circuit, the inverter circuit provided between first and second input terminals and first, second and third output terminals,
wherein the bridge circuit is configured by connecting in parallel
(A) a first series circuit including first and second switch elements connected in series to each other;
(B) a second series circuit including third and fourth switch elements connected in series to each other, and
(C) a third series circuit including fifth and sixth switch elements connected in series to each other,
wherein both ends of the first series circuit, both ends of the second series circuit, and both ends of the third series circuit are defined as first and second connection points, respectively, and are connected to the first and second input terminals via first and second inductances,
wherein a third connection point of the first and second switch elements is connected to the first output terminal via a third inductance,
wherein a fourth connection point of the third and fourth switch elements is connected to the second output terminal via a fourth inductance,
wherein a fifth connection point of the fifth and sixth switch elements is connected to the third output terminal via a fifth inductance, and
wherein the electric power converter circuit apparatus comprises:
a first impedance element connected between the third connection point and the first or second input terminal;
a second impedance element connected between the fourth connection point and the first or second input terminal;
a third impedance element connected between the fifth connection point and the first or second input terminal;
a fourth impedance element connected between the first output terminal and the first or second input terminal;
a fifth impedance element connected between the second output terminal and the first or second input terminal; and
a sixth impedance element connected between the third output terminal and the first or second input terminal.

17. The electric power converter circuit apparatus as claimed in claim 16,
wherein each of the first to sixth impedance elements includes any of:
(1) a fourth series circuit of an inductor and a capacitor;
(2) a circuit further including a resistor in series or in parallel with the inductor in the fourth series circuit; and
(3) a fifth series circuit of a bead and a capacitor.

18. The electric power converter circuit apparatus as claimed in claim 16,
wherein each of the inductances included in the first to third impedance elements is L2,
wherein a parallel inductance of an effective inductance between the first input terminal and the first connection point, and an inductance that is half of the inductance L2 is L1 when the first and second input terminals are short-circuited and the first and second connection points are short-circuited,
wherein each of inductances included in the fourth to sixth impedance elements are L3, and the third to fifth inductances is L4, and
wherein the inductances L1 to L4 are set such that L1:L2=L3:L4.

19. The electric power converter circuit apparatus as claimed in claim 16,
wherein each of inductances included in the first to third impedance elements is L2,
wherein a parallel inductance of an effective inductance between the first input terminal and the first connection point, and an inductance that is half of the inductance L2 is L1 when the first and second input terminals are short-circuited and the first and second connection points are short-circuited,
wherein each of inductances included in the first to third impedance elements are L2, inductances included in the fourth to sixth impedance elements are L3, and the third to fifth inductances is L4, and
wherein the inductances L1 to L4 are set such that a coefficient “a” satisfies 0.5≤a≤1.5 in the following equation:
$$L 1 ( L 1 + L 2 ) = a \times L 3 / ( L 3 + L 4 ) .$$

20. The electric power converter circuit apparatus as claimed in claim 16, further comprising:
a seventh impedance element connected between the third connection point and the third output terminal;
an eighth impedance element connected between the third connection point and the second output terminal;
a ninth impedance element connected between the fourth connection point and the third output terminal;
a tenth impedance element connected between the fourth connection point and the first output terminal;
an eleventh impedance element connected between the fifth connection point and the first output terminal; and
a twelfth impedance element connected between the fifth connection point and the second output terminal.

21. The electric power converter circuit apparatus as claimed in claim 20,
wherein each of the seventh to twelfth impedance elements includes any of:
(1) a sixth series circuit of an inductor and a capacitor;
(2) a circuit further including a resistor in series or in parallel with the inductor in the sixth series circuit; and
(3) a seventh series circuit of a bead and a capacitor.

22. The electric power converter circuit apparatus as claimed in claim 20,
wherein the third to fifth inductances and inductances included in the seventh to the twelfth impedance elements are substantially equal to each other.

23. The electric power converter circuit apparatus as claimed in claim 20,
wherein a parallel inductance of L2/2 and an effective inductance between the first input terminal and the first connection point is L1 when the first and second input terminals are short-circuited and the first and second connection points are short-circuited,
wherein each of inductances included in the first to third impedance elements is L2,
wherein a parallel inductance of each inductance included in the fourth to sixth impedance elements, and half of each inductance included in the seventh to twelfth impedance elements is L3, and
wherein the third to fifth inductances are L4, the inductances L1 to L4 are set such that L1:L2=L3:L4.

24. The electric power converter circuit apparatus as claimed in claim 20,
wherein each of inductances included in the first to third impedance elements are L2,
wherein a parallel inductance of L2/2 and an effective inductance between the first input terminal, and the first connection point is L1 when the first and second input terminals are short-circuited and the first and second connection points are short-circuited,
wherein a parallel inductance of each of inductances included in the fourth to sixth impedance elements and half of each of inductances included in the seventh to twelfth impedance elements is L3,
wherein each of the third to fifth inductances is L4, and
wherein the inductances L1 to L4 are set such that a coefficient “a” satisfies 0.5≤a≤1.5 in the following equation:
$$L 1 ( L 1 + L 2 ) = a \times L 3 / ( L 3 + L 4 ) .$$

25. An electric power converter circuit apparatus comprising:
an inverter circuit including a bridge circuit, the inverter circuit provided between first and second input terminals and first and second output terminals,
wherein the bridge circuit is configured by connecting in parallel: a first series circuit including first and second switch elements connected in series to each other; and a second series circuit including third and fourth switch elements connected in series to each other,
wherein both ends of the first series circuit and both ends of the second series circuit are defined as first and second connection points, respectively, and are connected to the first and second input terminals via first and second inductances,
wherein a third connection point of the first and second switch elements is connected to the first output terminal via a third inductance,
wherein a fourth connection point of the third and fourth switch elements is connected to the second output terminal via a fourth inductance, and
wherein the electric power converter circuit apparatus comprises:
a first impedance element connected between the third connection point and the first or second input terminal;
a second impedance element connected between the fourth connection point and the first or second input terminal;
a third impedance element connected between the first output terminal and the first or second input terminal; and
a fourth impedance element connected between the second output terminal and the first or second input terminal,
wherein the electric power converter circuit apparatus further comprises:
a noise filter circuit connected to an input terminal of the electric power converter circuit apparatus; and
a three-phase motor connected to an output terminal of the electric power converter circuit apparatus.
